(19) United States
(12) Patent Application Publication
(10) Pub. No.: US 2014/0240313 A1
(43) Pub. Date: Aug. 28, 2014

(54) COMPUTER-AIDED SYSTEM FOR 360° HEADS UP DISPLAY OF SAFETY/MISSION CRITICAL DATA

(71) Applicant: Kenneth A. Varga, Phoenix, AZ (US)

(72) Inventor: Kenneth A. Varga, Phoenix, AZ (US)

(73) Assignee: Real Time Companies, Phoenix, AZ (US)

(21) Appl. No.: 14/271,061

(22) Filed: May 6, 2014

Related U.S. Application Data
(63) Continuation-in-part of application No. 12/460,552, filed on Jul. 20, 2009, now abandoned.
Application No. 12/460,552 is a continuation-in-part of application No. 12/383,112, filed on Mar. 19, 2009, now abandoned.

(51) Int. Cl. G06T 19/00; G06F 3/01

(52) U.S. Cl. CPC G06T 19/006; G06F 3/012; G06F 3/013
USPC 345/419; 345/156

(57) ABSTRACT

A Heads-Up-Display (“HUD”) system for projecting safety/mission critical data onto a display pair of light weight projection glasses or monocular creating a virtual 360 degree is disclosed. The HUD system includes a see-through display surface, a workstation, application software, and inputs containing the safety/mission critical information (Current User Position, Total Collision Avoidance System—TCAS, Global Positioning System—GPS, Magnetic Resonance Imaging—MRI Images, CAT scan images, Weather data, Military troop data, real-time space type markings etc.). The workstation software processes the incoming safety/mission critical data and converts it into a three-dimensional stereographic space for the user to view. Selecting any of the images may display available information about the selected item or may enhance the image. Predicted position vectors may be displayed as well as three-dimensional terrain.

### CROSS REFERENCE TO RELATED APPLICATIONS

This application is a continuation-in-part application claiming benefit to U.S. patent application Ser. No. 12/460,552 filed on Jun. 20, 2009, which is a continuation-in-part of U.S. patent application Ser. No. 12/383,112 filed on Mar. 19, 2009, which are herein incorporated by reference in their entirety.

### FIELD

This present disclosure generally relates to systems and methods for displaying various data onto a three-dimensional stereographic space, and in particular to systems and methods for displaying an augmented three-dimensional stereographic space such that movement of the user's head and/or eyes achieves different views of the augmented three-dimensional stereographic space corresponding to the direction of the user's gaze.

### BACKGROUND OF THE INVENTION

There are many critical perceptual limitations to humans piloting aircraft or other vehicles as well as doctors and medical technicians implementing procedures on patients, or operators trying to construct or repair equipment or structures, or emergency personnel attempting to rescue people or alleviate a dangerous situation. To overcome many of these perceptual limitations, a technique called augmented reality has been developed, to provide necessary and relevant information outside the immediate local perception of the user that is used to optimize the abilities of the user well beyond their natural local perception.

With the advent of advanced simulation technology and spherical cameras, the augmentation of three-dimensional surfaces onto a see-through display has become more and more feasible, combined with the ability to track the orientation of an operator's head and eyes and of objects in a system, or utilize known orientations of mounted see-through displays and data from sensors indicating the states of objects. The knowledge base of three-dimensional surfaces can be given the added benefit of augmentation as well as providing the ability to reasonably predict relative probabilities that certain events may occur. Such capabilities allows a user to not only have the visible surroundings augmented, but also view their surroundings in conditions where the visibility of the user is poor due to weather, dark skies, or occlusion by natural or man-made structures can allow the user to have an augmented telepresence as well as a physical presence.

For pilots of aircraft, many of these local perception limitations include occlusion by aircraft structures that may prevent the pilot from seeing weather conditions, icing on wings and control structures, conditions of aircraft structures, terrain, buildings, or lack of adequate day-light conditions.

To overcome some of these limitations, a head-mounted display system is described that allows a pilot to see, for example, a polygon-generated terrain, digital images from a spherical camera, and/or man-made structures represented in a polygon-shaped configuration on a head mounted semi-transparent display that tracks the orientation of the pilot's head and allows viewing of such terrain oriented with the position of the pilot's head even in directions occluded (blocked) by the aircraft structure. The pilot is provided with the ability to view the status of aircraft structures and functions by integrating aircraft sensors directly with the display and pilot's head orientation. However, further improvement in systems and methods that augments an individual's natural local perception is desired.

### BRIEF DESCRIPTION OF THE DRAWINGS

FIG. 1A is a block diagram of a heads-up-display (HUD) system having a pair of projection-type glasses with a microphone, earphones, and sensors with eye and head tracking;

FIG. 1B is a high-level system block diagram showing a plurality of HUD systems.

FIG. 2 is a diagram showing a pair of projection-type glasses with an optional microphone and earphones illustrated;

FIG. 3A is an augmented pilot view of an aircraft flight plan having critical and caution terrain shown, along with a “traffic out of sight” indicator;

FIG. 3B is an augmented pilot view of an aircraft having critical and caution terrain illustrated;

FIG. 3C is an augmented pilot view having caution terrain illustrated;

FIG. 4A is an augmented pilot view of the aircraft flight plan having a ribbon displayed with non-critical terrain;

FIG. 4B is an augmented pilot view of the aircraft flight plan having a flight plan ribbon displayed with a collision course warning with another aircraft above non-critical terrain;

FIG. 5 is an augmented pilot view of both terrain and of ground structures, where structures that are dangerous to the flight plan path are highlighted in the display.

FIG. 6 shows a hand-held pointing device that is used for controlling a display;

FIG. 7 shows an Air Traffic Control (ATC) tower view and ATC entered flight procedures;

FIG. 8 shows the ATC tower view with flight plan data illustrated;

FIG. 9 shows the ATC tower view with flight data and air collision alert illustrated;

FIG. 10 shows the ATC tower view with ground data and ground collision alert illustrated;

FIG. 11 shows the ATC tower view with lost signal and coasting illustrated;

FIG. 12 shows an ATC Regional Control Center (RCC) view;

FIG. 13 shows an augmented pilot view with predicted position vector shown with no other outside aircraft data.

FIG. 14 shows an ATC Regional Control Center view from an aircraft perspective as shown to the pilot;

FIG. 15 shows a military battlefield view in a map view mode;

FIG. 16 shows a military battlefield view in a map view army operations mode;

FIG. 17 shows a combined naval and ground view;

FIG. 18 shows a military battlefield view in an augmented ground view mode;

FIG. 19 shows a Military Control Center (MCC) view from a battlefield perspective;

FIG. 20 shows the ATC Tower view with storm intensity colors;

FIG. 21 shows a pilot view with weather;

FIG. 22 shows a battlefield view with weather;

FIG. 23 shows a HUD system application for navigating on a river, bay, or ocean with velocity vector and out of sight marine traffic;

FIG. 24 shows a HUD system application for optimizing a search and rescue operation with a team of coast guard vessels having optimized coordination of search areas with current flows identifying explored and unexplored areas;

FIG. 25 shows a HUD system application for a team of search and rescue units on a mountain displaying explored and unexplored areas;

FIG. 26 shows a HUD system application for a team of firefighters, or swat team in a multi-story building that displays personnel location and other critical information;

FIG. 27 shows a HUD system application for emergency vehicles to optimize routing through traffic;

FIG. 28 shows a HUD system application for leisure hikers;

FIG. 29 shows a HUD system application for a police/swat hostage rescue operation;

FIG. 30 shows a HUD system application for leisure scuba divers;

FIG. 31 shows a HUD system application for emergency vehicle (such as fire and police), delivery personnel, or for a real estate agent travelling on a street;

FIG. 32 shows a HUD system application for manufacturing an airplane;

FIG. 33 shows a HUD system application for repair of an airplane;

FIG. 34 shows a HUD system application for spelunking;

FIG. 35 shows a HUD system application for a motorcycle;

FIG. 36 shows a HUD system application optimizing a recover search operation of an ocean floor with mountainous regions comparing sensor data with known surface data;

FIG. 37 shows a HUD system application used by a submarine;

FIG. 38 shows an example process for generating a three-dimensional stereographic space;

FIG. 39 shows a computer architecture for the HUD system; and

FIG. 40 shows a general computing system for the HUD system.

### DETAILED DESCRIPTION

Aspects of the present disclosure involve methods and systems for displaying safety/mission critical data, in real-time, to users in a three-dimensional stereographic space to as a part of a virtual 360° heads-up-display (HUD) system, designated 1. In various aspects, software (i.e. instructions, functions, processes and/or the like) may be executed by the HUD system 1 to determine the orientation of a user interacting with an interface in operable communication with the HUD system 1. The HUD system 1 uses the orientation of the user in conjunction with geographical information/data to generate the three-dimensional stereographic space. Subsequently, augmentation data corresponding to a space of interest included within the three-dimensional stereographic space is received and processed by the HUD system 1 to generate an augmented view of the space of interest for display at the interface. The space of interest refers to an application-specific point of view provided to a user interacting with various aspects of the HUD System 1. For example, if the HUD system were being used in the context of a pilot and airspace application, the space of interest, included within the three-dimensional stereographic space, may include various view(s) oriented for a user, such as a pilot, related to piloting and/or airspace.

According to various embodiments, the HUD system 1 may be, be included in, or otherwise be a part of, a pair of transparent glasses, a helmet, or a monocle, or a set of opaque glasses, helmets, or monocles. The transparent or opaque glasses can be either a projection-type or embedded into a display, such as a flexible Organic Light Emitting Diode (OLED) display or other similar display technology. The HUD system 1 is not limited to wearable glasses, where other methods such as fixed HUD devices as well as see-through capable based hand-held displays can also be utilized if incorporated with remote head and eye tracking technologies and/or interfaces, or by having orientation sensors on the device itself.

A user, such as pilot can use the HUD display to view terrain, structures, and other aircraft nearby and other aircraft that have their flight plan paths in the pilot's vicinity as well as display this information in directions that are normally occluded by aircraft structures or poor visibility. Aside from viewing external information, the health of the aircraft can also be checked by the HUD system 1 by having a pilot observe an augmented view of the operation or structure of the aircraft, such as of the aileron control surfaces, and be able to view an augmentation of set, minimum, or maximum control surface position. The actual position or shape can be compared with an augmented view of proper (designed) position or shape in order to verify safe performance, such as degree of icing, in advance of critical flight phases, where normal operation is critical, such as during landing or take off of the aircraft. This allows a pilot to be more able to adapt in abnormal circumstances where operating surfaces are not functioning optimally.

In addition, pan, tilt, and/or spherical cameras mounted in specific locations to view the outside areas of the aircraft may be used to augment the occluded view of the pilot such that these cameras can follow the direction of the pilot's head and allow the pilot to see the outside of what would normally be blocked by the flight deck and vessel structures. For instance, an external gimbaled infrared camera can be used for a pilot to verify the de-icing function of aircraft wings to help verify that the control surfaces have been heated enough by verifying a uniform infrared signature and comparing it to expected normal augmented images. In other embodiments, other cameras, such as a spherical camera may be used. A detailed database on the design and structure, as well as full motion of all parts can be used to augment normal operation that a pilot can see, such as minimum maximum position of control structures. These minimum or maximum positions can be augmented in the pilot's HUD display so the pilot can verify control structures' operation and whether these control structures are functional and operating normally.

In another example, external cameras in visible and/or infrared, ultraviolet, and/or lowlight spectrum on a space craft can be used to help an astronaut easily and naturally verify the structural integrity of the spacecraft control surfaces, that may have been damaged during launch, or to verify the ability of the rocket boosters to contain plasma thrust forces before and during launching or re-entry to earth's atmosphere and to determine if repairs are needed and if an immediate abort is needed.

With the use of both head and eye orientation tracking, objects normally occluded in the direction of a user's gaze (as determined both by head and eye orientation) can be used to display objects hidden from normal view. This sensing of both the head and eye orientation can give the user optimal control of the display augmentation as well as an un-occluded omnidirectional viewing capability freeing the user's hands to do the work necessary to get a job done simultaneously and efficiently.

The user can look in a direction of an object and either by activating a control button or by speech recognition that selects the object. This can cause the object to be highlighted and the HUD system 1 can then provide further information (e.g., augmentation data) on the selected object. The user can also remove or add layers of occlusions by selecting and requesting a layer to be removed. As an example, if a pilot is looking at an aircraft wing, and the pilot wants to look at what is behind the wing, the pilot can select a function to turn off wing occlusion and have video feed of a gimbaled zoom camera positioned so that the wing does not occlude it. The camera can be oriented to the direction of the pilot's head and eye gaze, whereby a live video slice from the gimbaled zoom camera is fed back and projected onto the semi-transparent display onto the pilot's perception of the wing surface as viewed through the display by perceptual transformation of the video and the pilot's gaze vector. This augments the view behind the wing.

In some embodiments, the pilot or first officer can also select zoom even further behind the wing surface or other structure, giving beyond the capability of an “eagle eye” view of the world through augmentation of reality and sensor data from other sources, where the user's eyes may be used to control the gimbaled motion of the zooming telescopic camera, or spherical camera, etc.

In some embodiments of the HUD system 1, the captain or first officer can turn their head looking back into the cabin behind the locked flight deck door and view crew and passengers through a gimbaled zoom camera tied into the captain's or first officer's head/eye orientations to assess security or other emergency issues inside the cabin or even inside the luggage areas. Cameras underneath the aircraft may also be put to use by the captain or first officer to visually inspect the landing gear status, or check for runway debris well in advance of landing or takeoff, by doing a telescopic scan of the runway.

In some embodiments of the HUD system 1, gimbaled zoom-able camera perceptions, as well as augmented data perceptions (such as known three-dimensional surface data, three-dimensional floor plan, or data from other sensors from other sources) can be transferred between pilot, crew, or other cooperatives with each wearing a gimbaled camera, (or having other data to augment) and by trading and transferring display information. For instance, a first on the scene fire-fighter or paramedic can have a zoom-able gimbaled camera that can be transmitted to other cooperatives such as a fire chief, captain, or emergency coordinator heading to the scene to assist in an operation. The control of the zoom-able gimbaled camera can be transferred allowing remote collaborators to have a telepresence (transferred remote perspective) to inspect different aspects of a remote perception, allowing them to more optimally assess, cooperate and respond to a situation quickly. In other embodiments, a spherical camera may be used to provide the augmented data, augmented perceptions, and/or the like.

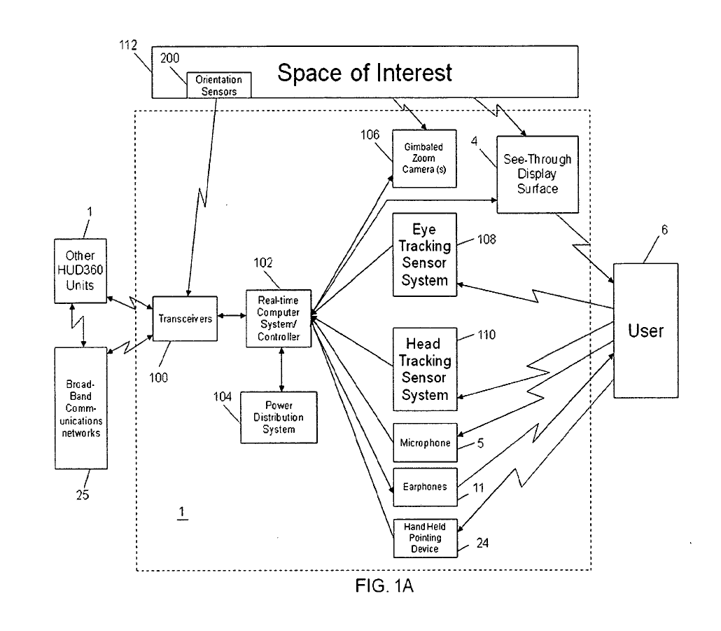

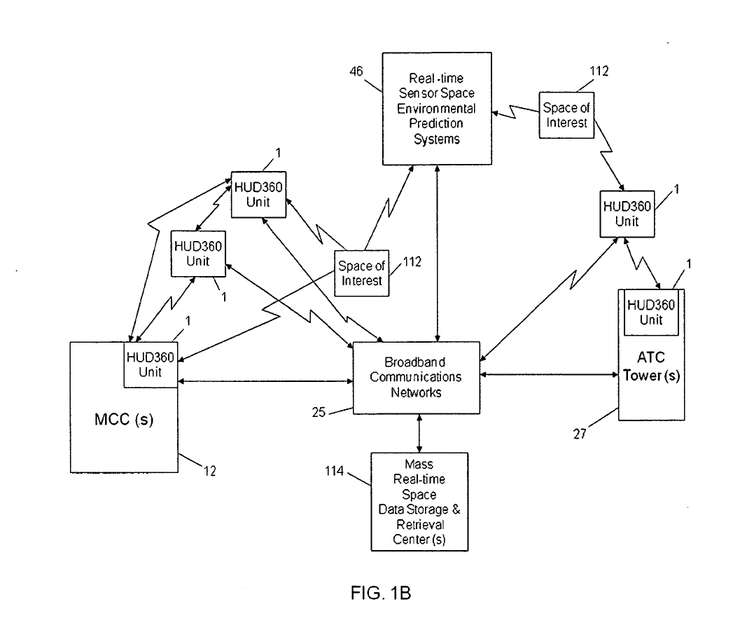

A functional system block diagram of a HUD system 1 with a see-through display surface 4 viewed by a user 6 of a space of interest 112 is shown in FIG. 1A. In some applications, the see-through display surface 4 can be set in an opaque mode where the entire see-through display surface 4 has only augmented display data where no external light is allowed to propagate through the see-through display surface 4. The see-through display surface 4 for the HUD system 1 is not limited to just a head mounted display or a fixed heads-up-display, but can be as simple as part of a pair of spectacles or glasses, an integrated hand-held device like a cell phone, Personal Digital Assistant (PDA), or periscope-like device, or a stereoscopic rigid or flexible microscopic probe with a micro-gimbaled head or tip (dual stereo camera system for depth perception), or a flexibly mounted device all with orientation tracking sensors in the device itself for keeping track of the device's orientation and then displaying augmentation accordingly.

Other features of the HUD system 1 may include a head tracking sub-system 110, an eye tracking sub-system 108, and a microphone 5 all of which are shown in FIG. 1A and all of which can be used as inputs with the ability to simultaneously control the augmented see-through display surface 4, or to control another available system selected by the user 6. Also shown is a pair of optional earphones 11 which can also be speakers to provide output to user 6 that can complement the augmented output of the see-through display surface 4. In some embodiments, an optional gimbaled zoom camera 106 that can be a lone camera or multiple independent cameras of various types that the user 6 of the HUD system 1 can view and control in real-time. The camera(s) 106 can be mounted on the goggles as an embedded part of the HUD system 1, or elsewhere and integrated as appropriate. Sensing and communications between user 6 and eye tracking sensor system 108, see-through display surface 4, head tracking sensor system 110, microphone 5, earphones 11, and hand-held pointing device 24 are shown as wireless, while to real-time computer system/controller 102 these components are shown as wired directly but can be wireless or wired depending on the desired application. All the functional blocks shown within HUD system 1 can be embedded or mounted within the goggles, worn by the user, or can be fixed away from the user 6 depending on the desired application. If the HUD system 1 is used as non-wearable device, such as a hand-held device, then the head tracking sensor system 110 can include both head tracking sensors and device orientation sensors where the orientation of the hand-held device as well as orientation of the head and eyes of the user 6 is measured and used to control augmentation of the see-through display surface 4.

In some embodiments, a real-time computer system/controller 102 may be in operative communication with the see-through display surface 4 to augment the see-through display surface 4, route and/or process signals between the user 6, camera(s) 106, eye-tracking sensor system 108, head tracking sensor system 110, microphone 5, earphones/speakers 11, hand held pointing (or other input such as a wireless keyboard and/or mouse) device 24 and transceiver 1 to other components of the HUD system 1 directly, or to other broadband communications networks 25. According to one embodiment, the real-time computer/system controller 102 may include one or more processors (not shown), a system memory (not shown), and system bus (not shown) that operatively couples the various components of the HUD system 1. There may be only one or there may be more than one processor, such that the processor of real-time computer/system controller 102 comprises a single central processing unit (CPU), or a plurality of processing units, commonly referred to as a parallel processing environment.

In some embodiments, transceiver 100 receives data from orientation sensors 200 within the space of interest 112. Optional relative orientation sensors 200 within the space of interest 112 provide orientation data along with the head tracking sensor system 110 (may include hand-held device orientation sensor if non-wearable HUD system 1 is used) along with eye tracking sensor system 108 to align and control augmentation on see-through display surface 4. The orientation sensors 200 on or in the space of interest 112 are used for the application of manufacturing or repair of a controlled structure to provide a frame of reference to use with the augmentation on the see-through display surface 4.

In some embodiments, a power distribution system 104 may be controlled by real-time computer system/controller 102 to optimize portable power utilization, where the power is distributed to all the functional blocks of the HUD system 1 that are mobile needing power and turned on, off, or low power state as needed to minimize power losses. Transceiver 100 can also serve as a repeater, router, or bridge to efficiently route broadband signals from other components of the HUD system 1 as a contributing part of a distributed broadband communications network 25 shown in FIG. 1B. Transceiver 100 can be made to send receive data such as Automatic Dependent Surveillance-Broadcast (ADS-B) data, but transceiver 100 is not limited to ADS-B, or to radio technology and can include other forms of transmission media such as from optical laser technology that carries traffic data or other collected data from other components of the HUD system 1 directly, indirectly, or receive data from mass real-time space data storage & retrieval centers 114 shown in FIG. 1B.

FIG. 1B is a high-level system view of a multiple configuration of the HUD system 1 cooperating together independently, or as part of an Air Traffic Control (ATC) Tower 27, or Military Control Center (MCC) 12 or other control center (not shown). The components of the HUD system 1 are shown to utilize direct path communications between each other if within range, or by using broadband communications networks 25 that can include terrestrial (ground networks) or extra-terrestrial (satellite) communication systems. The HUD system 1 can share information about spaces of interest 112 by communicating directly with each other, or through broadband communications networks 25. In addition, the components of the HUD system 1 can read and write to real-time space data storage and retrieval centers 114 via the broadband communications networks 25. All systems and data can be synchronized and standardized to common or multiple atomic clocks, not shown, and weighted accordingly by time reliability and probabilities, to improve accuracy and precision of real-time data. Predicted data can also be provided by real-time sensor space environmental prediction systems 46 such as from radars or satellite. Generally speaking, predicted data refers to any data that may be calculated or otherwise generated from other environment data, terrain data, user data, orientation data, or other data that the HUD system currently has available. For example, in the context of an aircraft application, if the aircraft flight plan is unknown, the HUD system 1 may calculate and/or generate the flight plan as predicted data based on, for example, position updates from a velocity vector corresponding to the aircraft. As another example, predicted data may refer to data providing information that a user may not be able to normally perceive due to human limitations. For example, a user may not be able to see behind an object displayed in the space of interest, but using radar data (or other sensor data, HUD system data, terrain data, etc.) the HUD system 1 may generate data predicting what is on the other side of the object (i.e. predicted data).

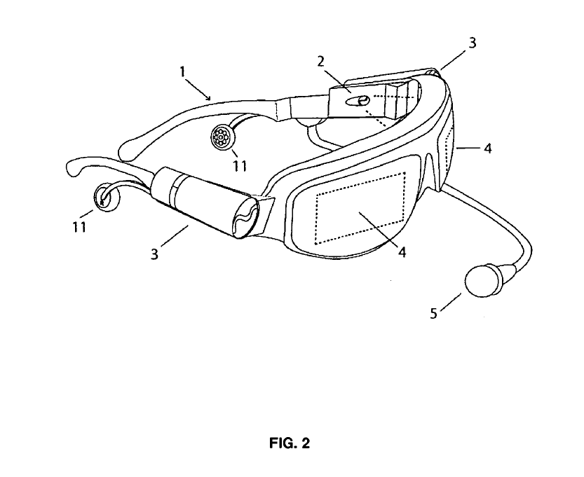

Referring to FIG. 2, lightweight see-through goggles with a display projection source that can also include eye-tracking sensors 2, head orientation sensors 3, see-through display surfaces 4 in the user's view, optional microphone 5, and optional earphones 11. The see-through display surface 4 is primarily used to augment the optical signals from the environment (space of interest 112 not shown) outside with pertinent data useful to the user of the display. This augmented data can be anything from real-time information from sensors (such as radars, cameras, real-time databases, satellite, etc.), or can implement applications used on a typical desk top computer laptop, cell phone, or hand held device such as a tablet, mobile device, mobile phone, and/or the like, where internet web browsing, text messages, e-mail, can be read from a display or through text to speech conversion to earphones 11 or written either by manually entering using an input device such as the eyes to select letters, or by an external input device such as a keyboard or mouse wirelessly integrated with HUD system 1, or by speech to text conversion by user speaking into microphone 5 to control applications.

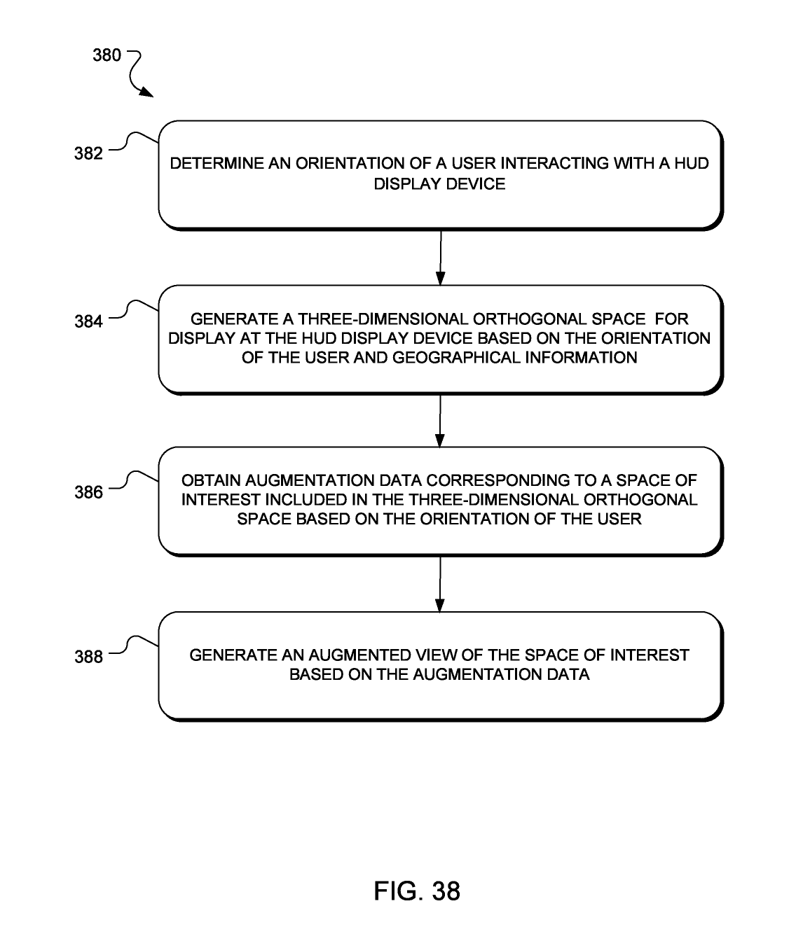

FIG. 38 is a flow chart illustrating a process 380 for augmenting optical signals of a three-dimensional stereographic space (e.g., an external environment) with augmented data. More specifically, the process 380 uses images of the three-dimensional stereographic space and the orientation of a user 6 to identify the space of interest 112. Once identified, the augmented data is transposed and/or otherwise displayed in conjunction with and/or as a part of the space of interest 112 to the user 6.

As illustrated, process 380 begins with determining the orientation of a user interacting with a HUD display device (operation 384). For example, a user may interact with a HUD display device, including one or more processors (e.g., the real-time computer system controller 102), microprocessors, and/or communication devices (e.g. network devices), such as the lightweight see-through goggles illustrated in FIG. 2. Generally speaking, determining the orientation of a user is a function performed by the HUD display device that is based on the orientation of the HUD display device (i.e. the lightweight see-through goggles) in relation to the user. For example, a determination of the orientation of the user correlates to determining the orientation of the see-through goggles when placed on a head of the user 6, in the direction the user 6 is oriented. Other orientations may include a true or magnetic north/south orientation, etc.

During user interaction with the HUD display device, an orientation signal may be received from the various components of the HUD display device (operation 384). With respect to the see-through goggles, an orientation signal may be received from the optional eye-tracking sensors 2, head orientation sensors 3, see-through display surfaces 4 in the user's view, optional microphone 5, and/or optional earphones 11. Based on the received orientation signal, an orientation of the user 6 may be determined. For example, in one embodiment, an orientation signal may be received from the eye-tracking sensors 2, which may be processed to determine the location of the user. Specifically, the sensors 3 may be mounted at eye-level on the device that is communicating with or otherwise includes the HUD system 1 so that the exact location, or altitude, of the eyes may be determined. Such data may (i.e. altitude) be processed with terrain or building data to determine whether a user is crawling, kneeling, standing, or jumping. Alternatively or in addition, orientation signals may be received or otherwise captured from the head orientation sensors 3, which may be for example from a compass (e.g. a digital or magnetic compass). Any one or more of the signals may be processed to determine/calculate a specific orientation of the user.

The determined orientation of the user and/or other geographical information may be used to generate the three-dimensional stereographic space, which may be generated according to “synthetic” processing, or to “digital” processing (operation 384). To generate the three-dimensional stereographic space synthetically, radar and/or sensor data may be received by the HUD display device that is processed to identify the geographic location of the space of interest 112 and/or objects within the space of interest. The system of claim 1, wherein geographical information includes at least two digital images of the space of interest and wherein the at least one processor is further configured to generate the three-dimensional stereographic space by stitching at least two digital images together with overlapping fields of view to generate the three-dimensional stereographic space 112. For example, in one embodiment, radar data is received from a Shuttle Radar Topography Mission system (“STRM”) (an example space data storage and retrieval center 114 described above) that provides high-resolution topographical information for the Earth. Accordingly, the STRM may provide radar data that identifies the space of interest 112 and related objects in the form of topographical information. While the above example involves the STRM, it is contemplated that terrain data could be obtained or otherwise retrieved from other system in other formats.

An example for synthetically generating a three-dimensional stereographic space for will now be provided. In the context of a pilot and an airplane, global-positioning data corresponding to the orientation of the user may be obtained and processed at the STRM to identify radar data corresponding topographical information related to the geo-location of the airplane. Subsequently, the radar data may be provided to the HUD display device (e.g. the see-through goggles) in the form of topographical data/information. While the above example refers generally to aircrafts and pilots, it is contemplated that other types of vehicles, machines, and the like may be involved, such as, automobiles, ships, aircraft carriers, trains, spacecraft, or other vessels, as well as be applied for use by technicians or mechanics working on systems. Further, other types of space data storage and retrieval centers 114 and/or space environmental prediction systems 46 may be accessed to receive radar and/or sensor data, or otherwise provide radar and/or sensor data, such as obstacle databases/systems capable of providing three-dimensional obstacle systems, terrain systems, weather systems, flight plan data, other aircraft data, and/or the like.

To generate the three-dimensional stereographic space digitally, multiple cameras may be used to capture images of the desired environment according to specific frame rate, for example, 30 frames per second. The captured images may be digitally stitched together in real-time to generate the three-dimensional stereographic sphere. Generally speaking, stitching refers to the process of combining multiple photographic images with overlapping fields of view to produce a single, high-resolution image. Thus, the HUD system 1 may implement or otherwise initiate a stitching process that processes the various images received from the multiple cameras to generate a single high-resolution image.

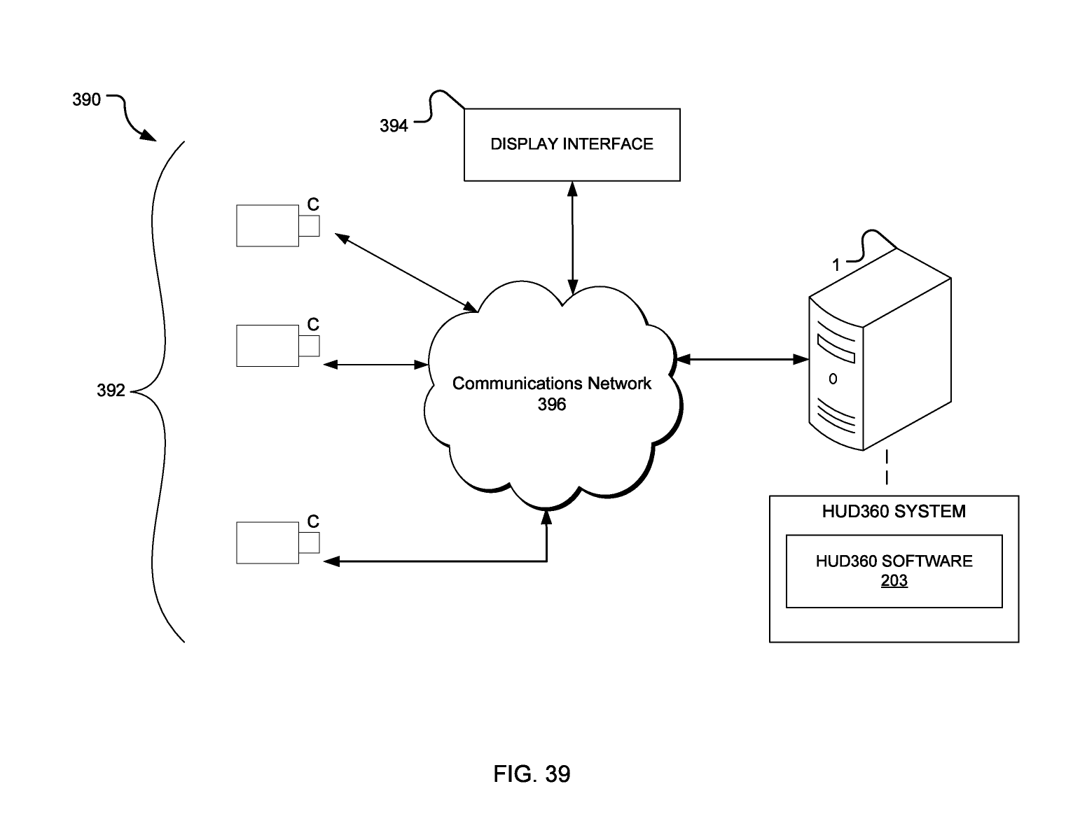

FIG. 39 provides an example of computing architecture 390 including a HUD system 1 that includes one or more cameras configured to capture and stitch digital images together to generate the three-dimensional stereographic space. As illustrated, the computing architecture 390 includes the HUD system 1 configured to provide various three-dimensional stereographic displays to users, such as for example, at the display interface 394. The data may be transmitted over a communication network 396, which may be the Internet, an Intranet, and Ethernet network, a wireline network, a wireless network, and/or another communication network. The display interface 394 may be a part of a personal computer, work station, server, mobile device, mobile phone, tablet device, of any suitable type. Moreover, while the HUD system 1 is depicted as being separate from the display interface 394, it is contemplated that the display interface and the HUD system 1 may be a part of, or otherwise included as components in the same device, such as for example, as components of a head-mountable device, such as the see-through goggles illustrated in FIG. 2.

The computing architecture 390 further includes one or more digital cameras 392 that are configured to capture digital images of real-world environment. In one embodiment, eight cameras may be deployed or otherwise used to capture digital images. In the eight-camera configuration, one camera may be pointing up, one camera may be pointing down, and the remaining six cameras may be pointed or otherwise spaced apart according to a sixty-degree spacing. In another embodiment, only six cameras may be used to capture the digital images with one camera pointing up, one camera pointing down, and the remaining four cameras pointing according to ninety-degree spacing.

In one embodiment, separate digital images may be captured by the plurality of cameras 392 for both the right and left eye of the user interacting with the HUD display device, such as the see-through goggles. The digital images received for each eye may include a difference of seven (7) degrees. Stated differently, the digital images for the right eye may be, in one embodiment, of a 7 degree difference in relation to the digital images for the left eye. Receiving images for each eye at a seven degree difference enables images for both eyes to be combined to provide depth-perception to the various views identified within the space of interest 112 of the three-dimensional stereographic space displayed at the HUD display device.

Once the three-dimensional stereographic space has been generated, augmented data is obtained (operation 386) and provided for display within the three-dimensional stereographic space. More specifically, augmented data is added to, or presented in, the space of interest 112 to generate an augmented view as a partially transparent layer (operation 388). The augmented data used to generate the augmented view may include historical images or models, representing what various portions of the space of interest 112 looked like at a previous point in time. Alternatively, the augmented data may include images illustrating what portions of the space of interest 112 looked like at a future period of time. In yet another example, the augmented data may provide an enhancement that provides additional information and context to the space of interest 112. The augmentation occurs when synthetic data is placed on or otherwise integrated with digital data captured from the cameras 392. For example, for a pilot, a space of interest 112 may include everything visible within and around the aircraft the pilot is controlling and the cameras 392 may send any captured digital images to the HUD System 1. The HUD system 1 may overlay the digital images with data such as terrain data from a terrain database, man-made structures from an obstacle database, color-coded terrain awareness alerts, etc. Any one of such overlays augments the digital camera images.

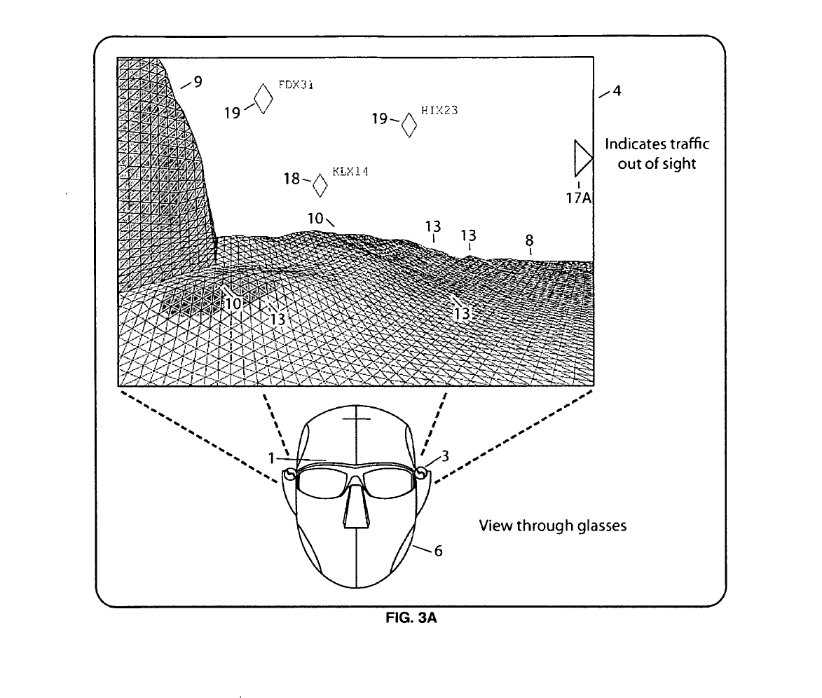

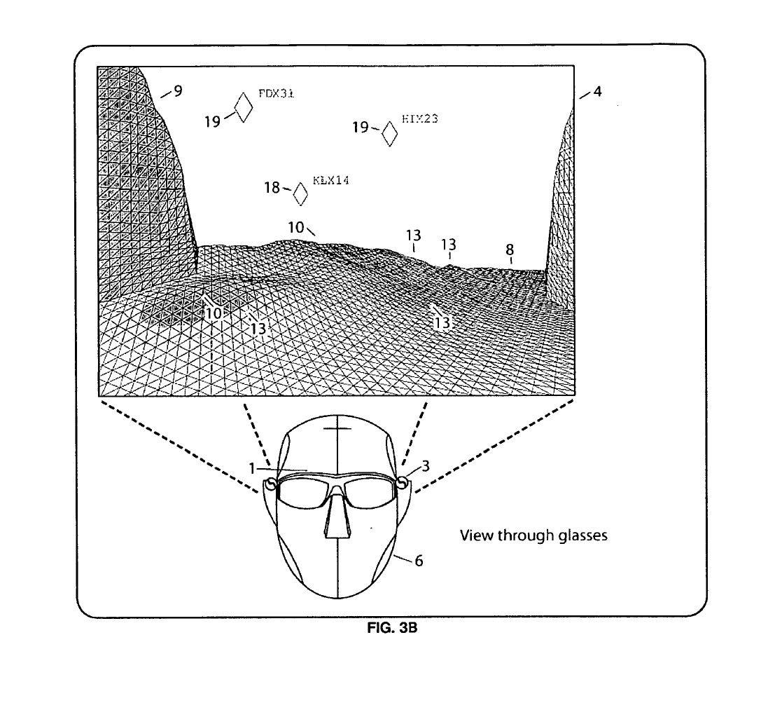

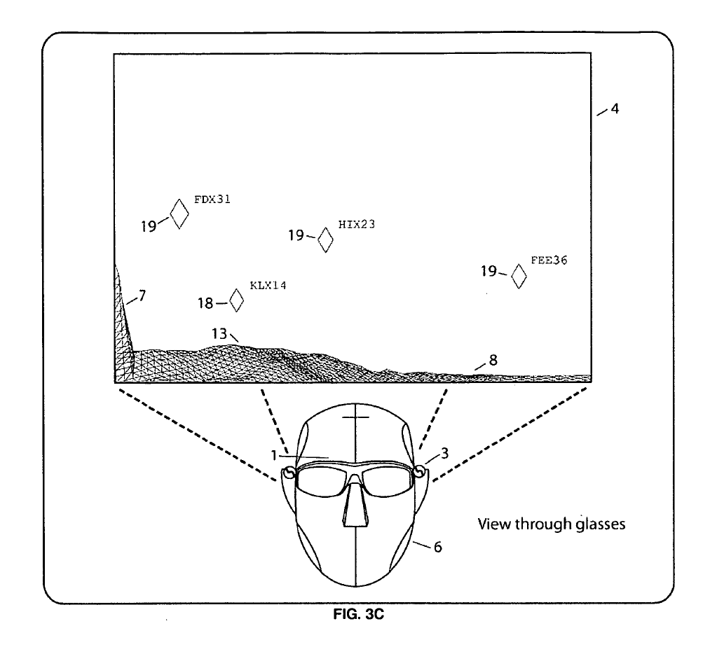

FIGS. 3A-5 illustrate various augmented views capable of being generated by the HUD system 1. More specifically, an augmented perception of a pilot view with a HUD system 1 is shown in FIGS. 3A, 3B, 3C, 4A, 4B, 5, 13 and 21.

FIG. 3A shows the augmented perception of a pilot view using a HUD system 1 where safe terrain surface 8, cautionary terrain surface 13, and critical terrain surfaces 9 and 10 are identified and highlighted. Aircraft positions are also augmented on the HUD display device as an aircraft 18 on a possible collision course with critical terrain surface 9 as a mountain on the left of the see through display surface 4 (can be displayed in red color to differentiate (not shown). Also shown is aircraft 19 not on a possible collision course (can be displayed in another color (not shown), such as green, to differentiate from possible collision course aircraft 18). Aircraft out of sight 17A is augmented on the see-through display surfaces 4 that is shown in the direction relative to the pilot's direction of orientation, are indicated in their direction on the see-through display edge and can be colored accordingly to indicate if it is an out-of-sight collision course (not shown) or non-collision course aircraft 17A. Other out of sight indicators not shown in the figure can be displayed and are not limited to aircraft such as an out-of-sight indicator for an obstruction or mountain, etc., and the seriousness of the obstruction can be appropriately indicated such as by color or flashing, etc. Aircraft out of sight and on a collision course can also be indicated in their direction to see on the display edge though not shown in the figures. Critical surface 10 can be colored red or some other highlight so that it is clear to the pilot that the surface is dangerous. Cautionary surface 13 can be colored yellow or some other highlight so that it is clear to the pilot that the surface can become a critical surface 10 if the aircraft gets closer or if the velocity of the aircraft changes such that the surface is dangerous. Safe terrain surface 8 can be colored green or some other highlight so that it is clear to the pilot that the surface is not significantly dangerous. Other highlights or colors not shown in the figures can be used to identify different types of surfaces such as viable emergency landing surfaces can also be displayed or colored to guide the pilot safely down.

Aircraft direction, position, and velocity are also used to help determine if a landscape such as a mountain or a hill is safe and as shown in FIG. 3B this terrain is highlighted as a critical surface 9 (can be colored red) or as a safe terrain surface 8 (can be colored green). These surfaces can be highlighted and/or colored in the see-through display view 4 so that it is clear to the pilot which surface needs to be avoided and which surface is not significantly dangerous to immediately fly towards if needed.

FIG. 3C shows another view through the HUD system 1 with no critical surfaces highlighted, but a cautionary surface 13, and safe terrain surface 8 along with aircraft not on collision course 19 as well as an aircraft 18 on a possible collision course. In some embodiments, a critical terrain out-of-view indicator (not shown) can also be displayed on the edge of the see-through display surface 4 in the direction of the critical terrain out of view.

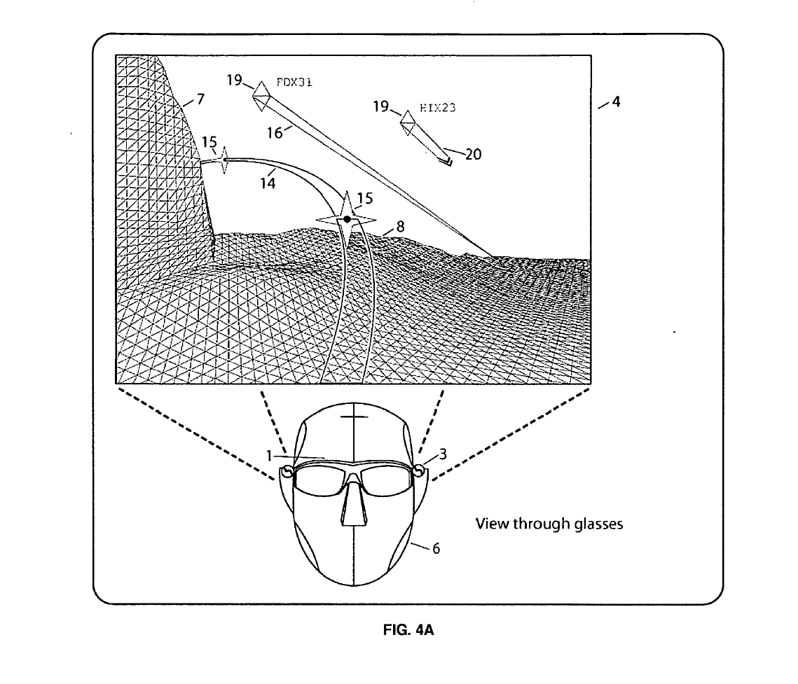

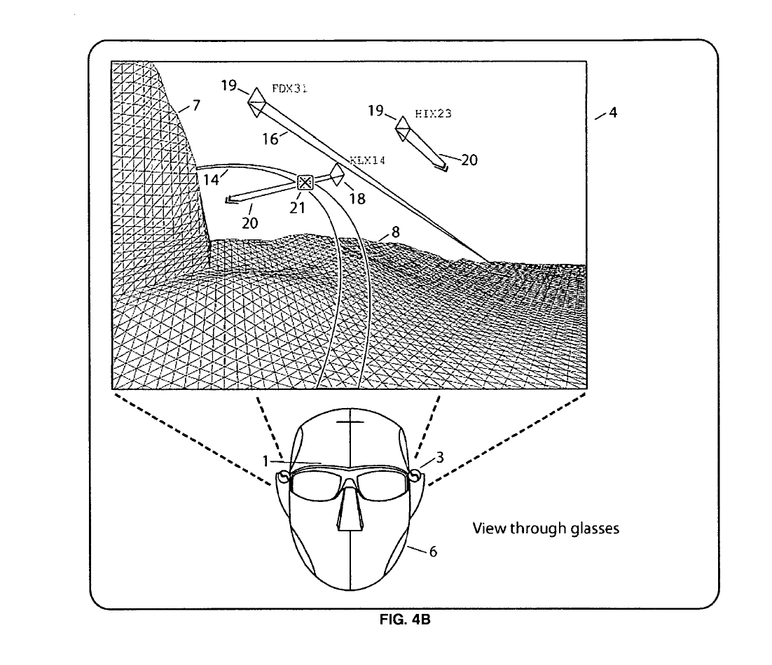

Shown in FIG. 4A is another view of the HUD system 1 with no critical surfaces highlighted, shows the pilot's aircraft flight plan path 14 with two way points identified 15, with aircraft 19 that has a known flight plan 16 displayed along with another aircraft 19 with only a predicted position vector 20 known. The predicted position vector 20 is the predicted position the pilot must respond to, in order to correct the course in time, and is computed by the velocity and direction of the vessel.

A possible collision point 21 is shown in FIG. 4B in see through display surface 4 where the HUD system 1 shows the pilot's aircraft flight plan path 14 intersecting at predicted collision point 21 with aircraft 18 with known predicted position vector 20 all over safe terrain surfaces 8 and 7.

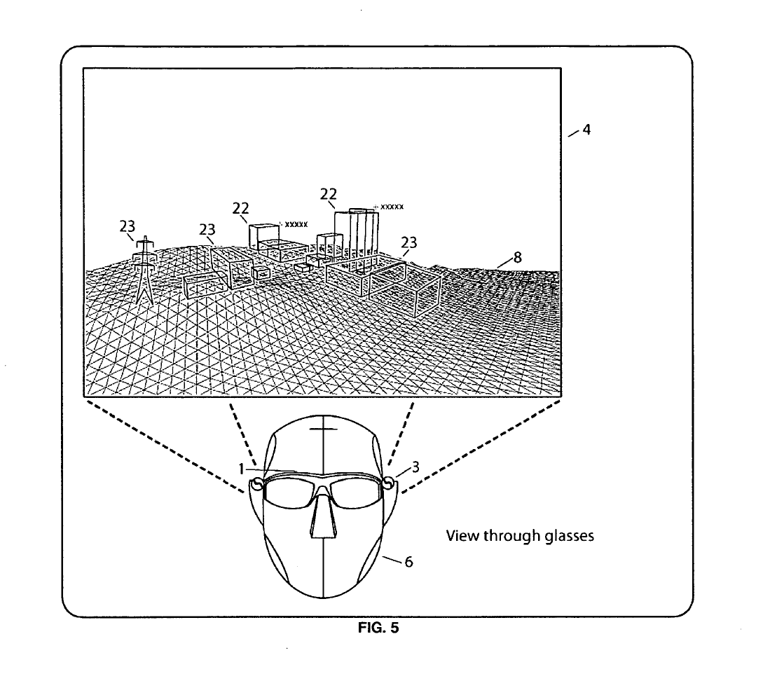

Critical ground structures 22 are highlighted to the pilot in the see-through display surface 4 shown in FIG. 5 where non-critical structures 23 are also shown in the see-through display surface 4 on HUD system 1 on top of non-critical terrain surface 8.

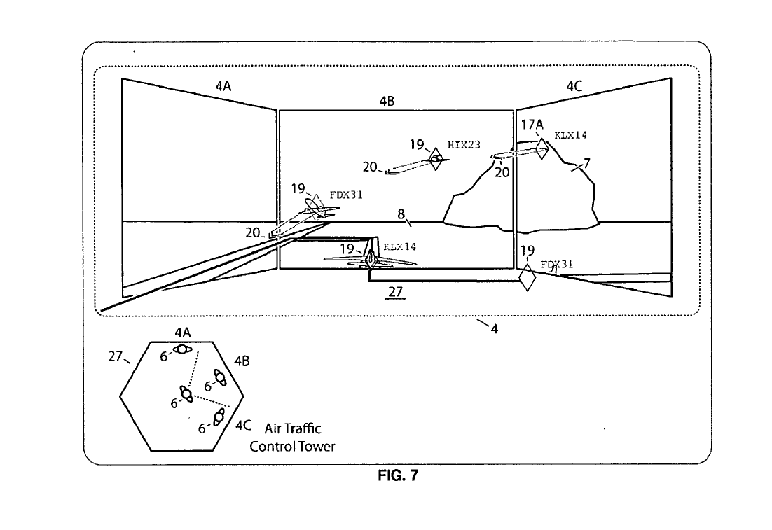

FIGS. 7, 8, 9, 10, 11 and 12 show another embodiment of the invention as an augmented perspective of an air traffic controller inside an Air Traffic Control (ATC) tower.

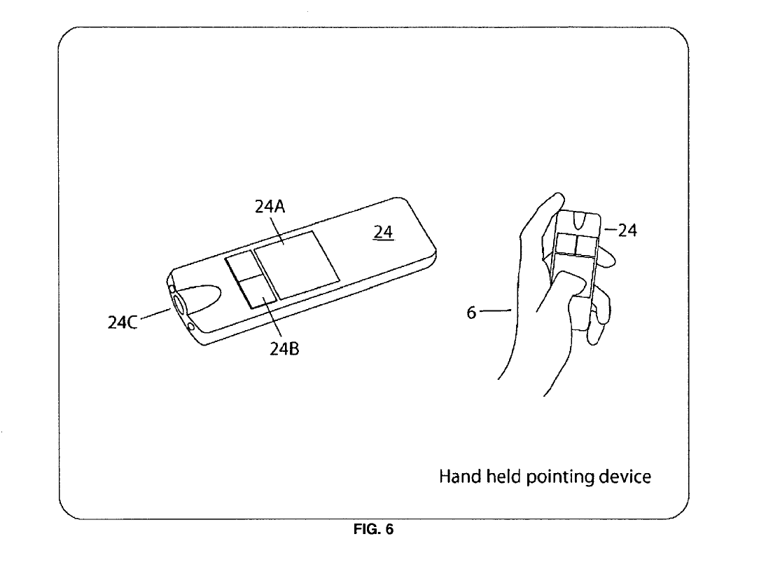

A pointing device 24 shown in FIG. 6 is used by user 6 to control the HUD system 1 with a thumb position sensor 24A, mouse buttons 24B, and pointing sensor 24C that can also serve as a laser pointer.

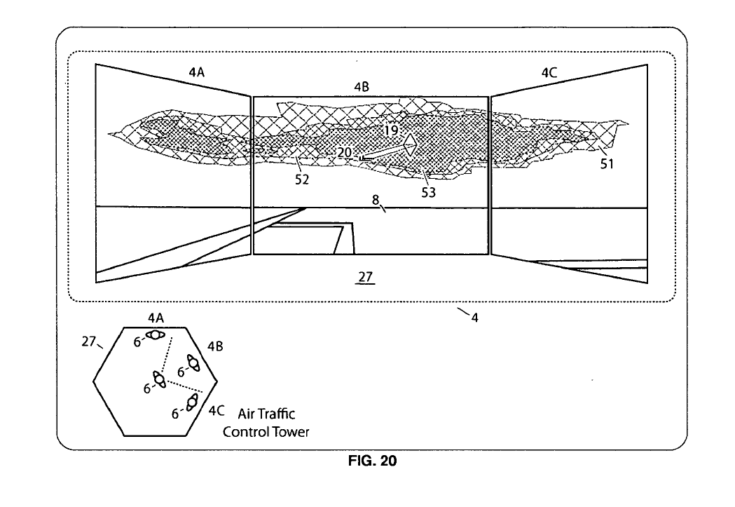

Three planar windows (4A, 4B, and 4C) for the see-through display surface 4 are shown from inside an ATC tower in FIG. 7 where three aircraft 19 in planar window 4B with a third aircraft 19 in planar window 4C occluded by non-critical mountain surface 7 with predicted position vectors 20 and a fourth aircraft 19 shown at bottom of planar window 4C. Also shown in FIG. 7 is a top view of the ATC tower with four viewing positions shown inside the tower, where planar windows 4A, 4B, and 4C are the tower windows, with the upper portion of FIG. 7 as the center perspective centered on planar window 4B, with planar windows 4A and 4C also in view. Although not shown, all planar window surfaces (omni-directional) of the ATC tower windows can have a fixed see-through display surface 4 where the augmented view can apply, and further a see-through or opaque display surface 4 on the ceiling of the tower can also be applied as well as out-of-sight aircraft indicators 17A and 17B displayed on the edge of the display nearest the out-of-sight aircraft position, or a preferred embodiment with the goggles can be used in place of the fixed HUD system 1. Safe terrain surface 8 and safe mountain surface 7 is shown in FIGS. 7-11 and safe terrain surface 8 is shown in FIG. 20. Although not shown, in some embodiments critical surfaces 9 and 10, cautionary terrain surfaces 13, and critical structures 22 can be augmented and displayed to the ATC personnel to make more informative decisions on optimizing the direction and flow of traffic.

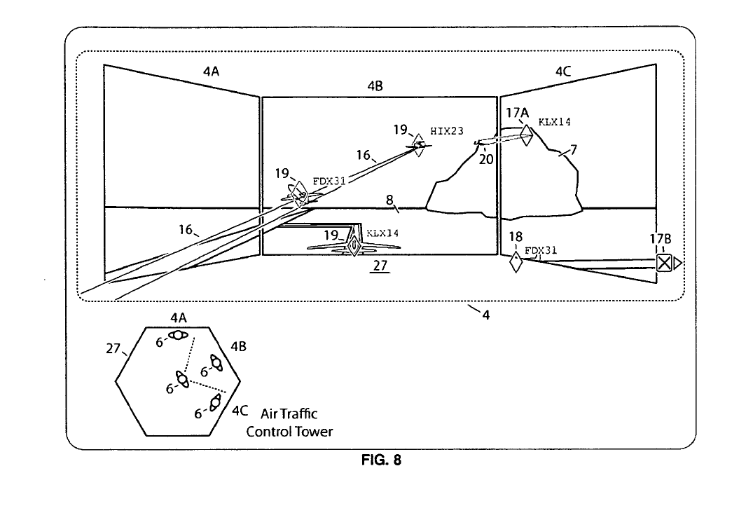

FIG. 8 shows a total of six aircraft being tracked see-through display surface 4 from an ATC tower perspective. Three aircraft 19 are shown in-sight through ATC window 4B that is not on collision courses with flight plan paths 16 shown. In ATC window 4C an out of sight aircraft 17A occluded by non-critical mountain surface 7 is shown with predicted position vector 20. Also shown in FIG. 8, through planar window 4C, is out of sight indication 17B of a collision bound aircraft heading towards probable collision aircraft 18 augmented on bottom of planar window 4C.

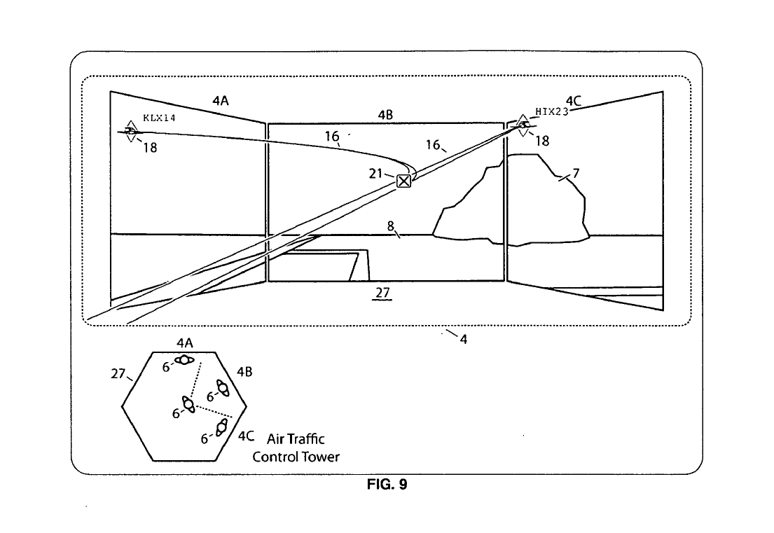

FIG. 9 shows an ATC tower 27 with a see-through display surface 4 from a user 6 viewing ATC planar windows 4A, 4B, and 4C where two aircraft 18 on a predicted air collision course point 21 along flight plan paths 16 derived from flight data over safe terrain 8 and safe mountain surface 7.

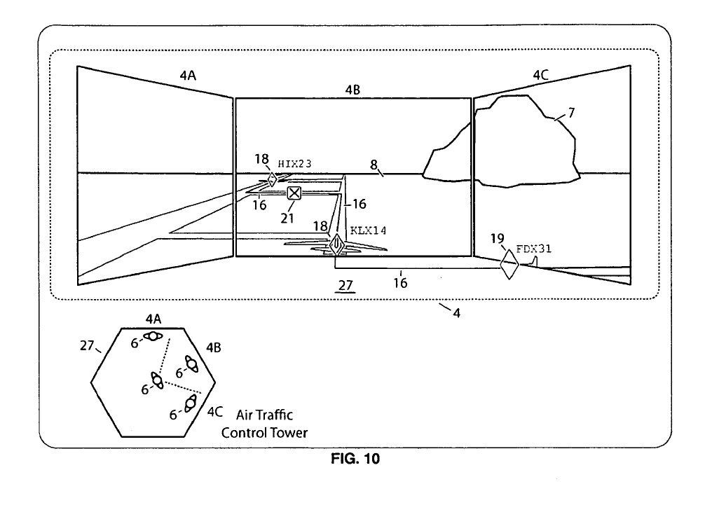

FIG. 10 shows an ATC tower 27 having a see-through display surface 4 with a predicted ground collision point 21 between two aircraft 18 with flight plan paths 16 on safe surface 8 with safe mountain surface 7 shown. See-through display surface 4 is shown from user seeing through ATC planar windows 4A, 4B, and 4C. Aircraft 19 that is not on a collision course is shown through ATC planar window 4C.

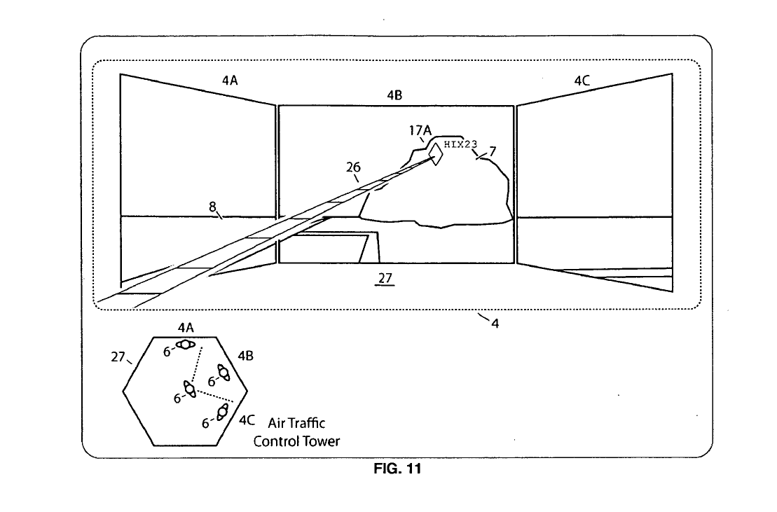

FIG. 11 shows an ATC tower 27 having a see-through display surface 4 from user 6 viewing through ATC planar windows 4A, 4B, and 4C. As shown an aircraft 17A is occluded by a determined as safe mountain terrain surface 7 from last known flight data, where the flight data is latent, with the last predicted flight plan path 26 shown over safe terrain surface 8. The safe mountain terrain surface 7 is identified as safe in this example and in other examples in this invention, because the last known position of the aircraft was far enough behind the mountain for it not to be a threat to the aircraft 17A.

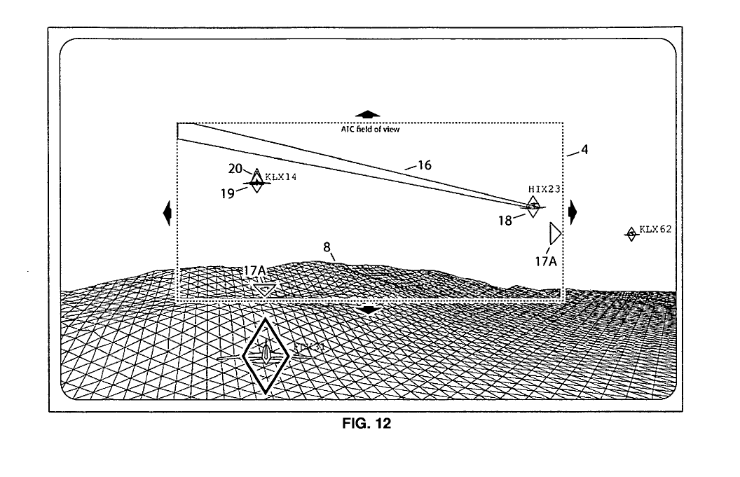

For regional ATC perspective, FIG. 12 demonstrates a telepresence view of a selected aircraft on an ATC view for the see-through display surface 4 (with the see-through display surface 4 in opaque or remote mode) over probable safe terrain surface 8 with one aircraft 19 in sight with predicted position vector 20 shown, that is not on a collision course. A second aircraft 18 in sight and on a collision course from aircraft predicted position data is shown (with collision point 21 outside of view and not shown in FIG. 20). Out-of-sight aircraft indicators 17A are shown on the bottom and right sides of the ATC see-through display surface 4 to indicate an aircraft outside of the see-through display surface 4 that are not on a collision course. The user 6 (not shown) can move the see-through display surface 4 (pan, tilt, zoom, or translate) to different regions in space to view different aircraft in real-time, such as the aircraft shown outside display view 4 and rapidly enough to advert a collision.

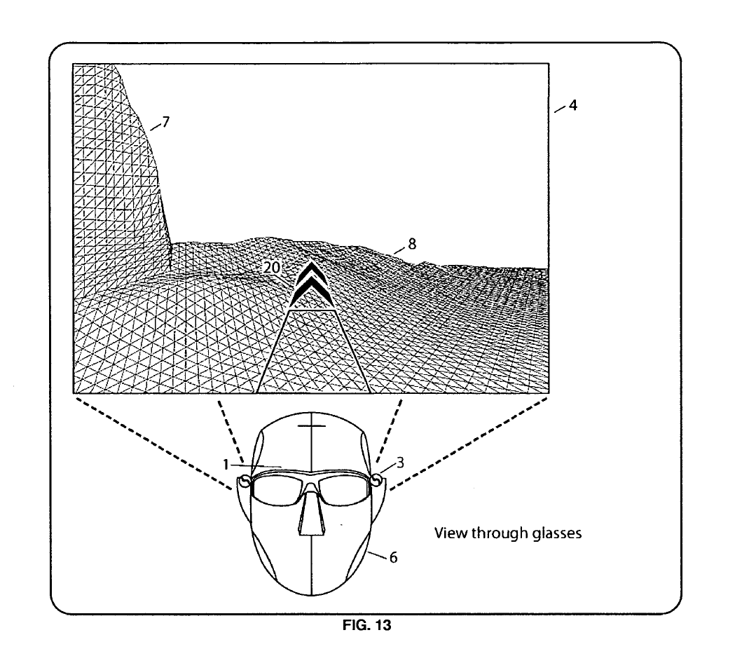

FIG. 13 shows a pilot view for the see-through display surface 4 with predicted position vector 20 over safe terrain surface 8, but no flight plan data is displayed.

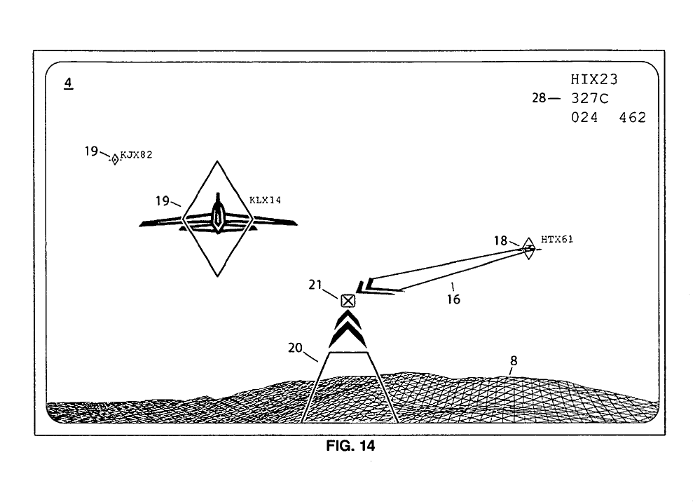

FIG. 14 provides an ATC or Regional Control Center (RCC) view for the see-through display surface 4 of a selected aircraft identified 28 showing predicted aircraft predicted position vector 20 over safe terrain surface 8 along with two in-sight aircraft 19 that are not on a collision course, and a third in-sight aircraft 18 that is on a predicted collision point 21 course along flight plan path 16.

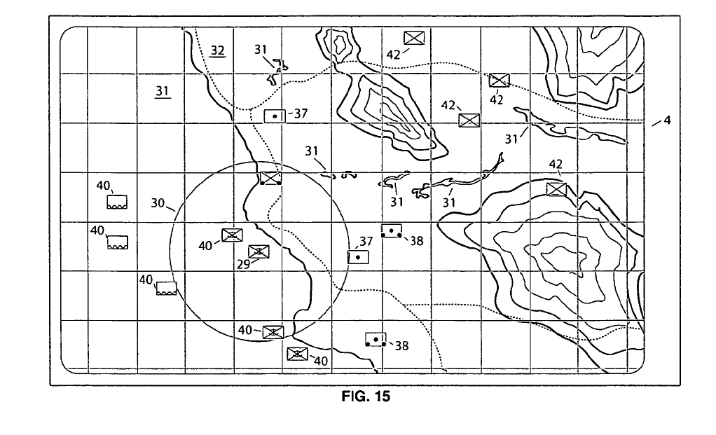

FIGS. 15, 16, and 17 demonstrate a see-through display surface 4 of different battlefield scenarios where users can zoom into a three dimensional region and look at and track real time battle field data, similar to a flight simulator or “Google Earth” application but emulated and augmented with real-time data displayed, as well as probable regional space status markings displayed that can indicate degree of danger such as from sniper fire or from severe weather. The system user can establish and share telepresence between other known friendly users of the system, and swap control of sub-systems such as a zoom-able gimbaled camera view on a vehicle, or a vehicle mounted gimbaled weapon system if a user is injured, thereby assisting a friendly in battle, or in a rescue operation. Users of the system can also test pathways in space in advance to minimize the probability of danger by travelling through an emulated path in see-through display surface 4 accelerated in time, as desired, identifying probable safe spaces 34 and avoiding probable cautious space 35 and critical space 36 that are between the user's starting point and the user's planned destination. A user can also re-evaluate by reviewing past paths through space by emulating a reversal of time. The identification of spaces allows the user to optimize their path decisions, and evaluate previous paths.

In FIG. 15 battlefield data of all unit types is shown on a three-dimensional topographical see-through display surface 4 in real time where a selected military unit 29 is highlighted to display pertinent data such as a maximum probable firing range space 30 over land 32 and over water 31. The probable unit maximum firing range space 30 can be automatically adjusted for known physical terrain such as mountains, canyons, hills, or by other factors depending on the type of projectile system. Unit types shown in FIG. 15 are shown as probable friendly naval unit 40, probable friendly air force unit 37, probable friendly army unit 38, and probable unfriendly army unit 42.

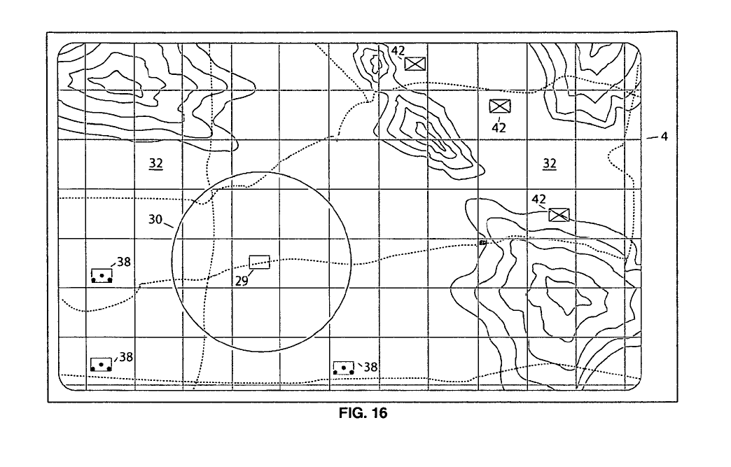

FIG. 16 shows an aerial battlefield view for the see-through display surface 4 with selected unit 29 on land 32. The selected unit 29 is identified as a probable motorized artillery or anti-aircraft unit with a probable maximum unit firing space 30 near probable friendly army units 38. Probable unfriendly army units are shown on the upper right area of FIG. 16.

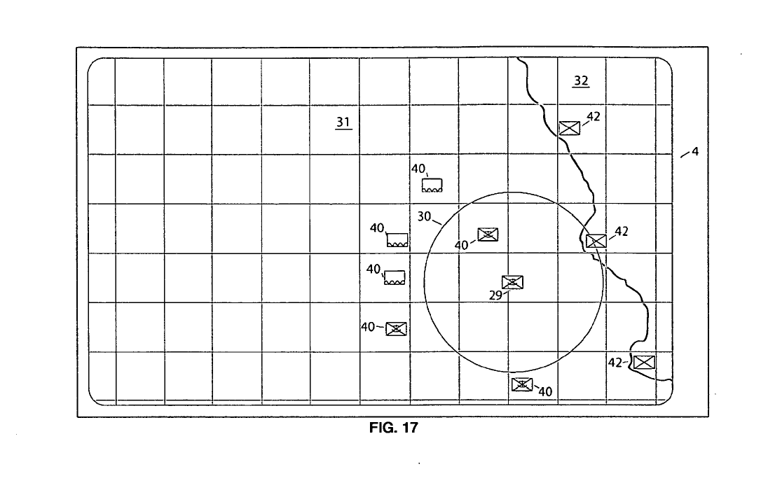

FIG. 17 shows a naval battlefield view for the see-through display surface 4 with selected unit 29 on water 31 with probable firing range 30 along with probable friendly navy units 40 along with probable unfriendly army units 42 on land 32.

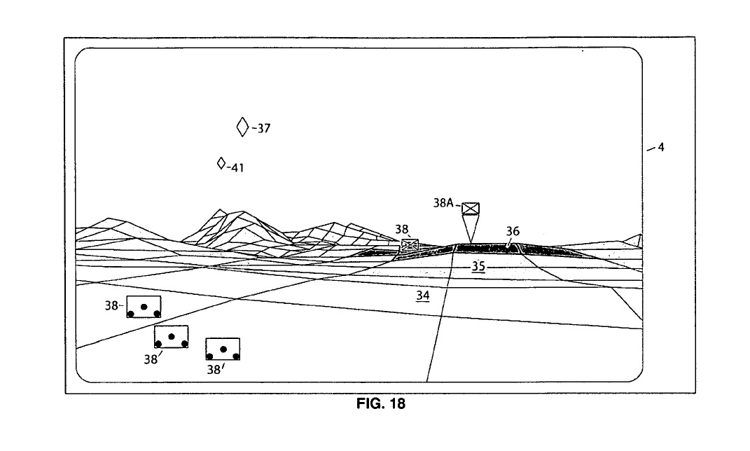

FIG. 18 shows a military battlefield see-through display surface 4 with probable friendly army units 38 and out of sight probable friendly army unit 38A, and probable unfriendly air-force unit 41 being intercepted by probable friendly air-force unit 37 (evidence of engagement, although not explicitly shown, such as a highlighted red line between probable unfriendly air-force unit 41 and probable friendly air-force unit 37, or some other highlight, can be augmented to show the engagement between units). Probable safe spaces (“green zone”) 34, probable cautious battle spaces (“warm yellow zone”) 35, and probable critical battle spaces (“red hot zone”) 36, all of which are weighted in probability by time and reporting, are also shown. The battle space status types 34, 35, and 36, can be determined by neural network, fuzzy logic, known models, and other means with inputs of reported weighted parameters, sensors, and time based decaying weights (older data gets deemphasized where cyclical patterns and recent data get amplified and identified). Unit types are not limited to the types described herein but can be many other specific types or sub-types reported, such as civilian, mobile or fixed anti-aircraft units, drones, robots, and mobile or fixed missile systems, or underground bunkers. Zone space type identification can be applied to the other example applications, even though it is not shown specifically in all of the figures herein. The terrain status types are marked or highlighted on the display from known data sources, such as reports of artillery fire or visuals on enemy units to alert other personnel in the region of the perceived terrain status.

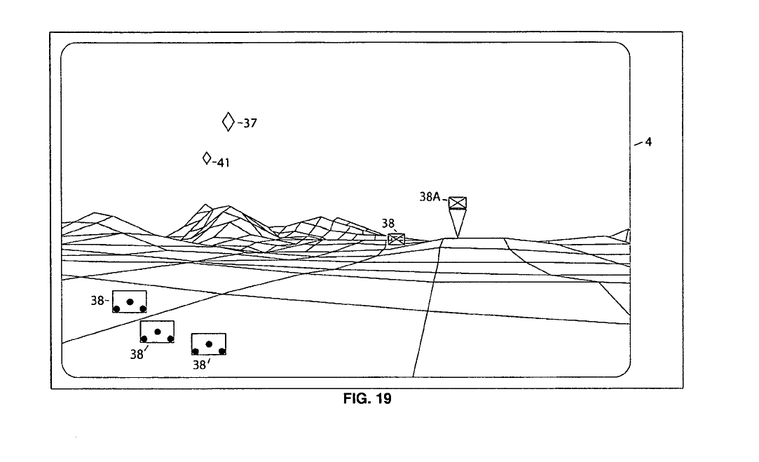

In FIG. 19 a Military Control Center (MCC) perspective for the see-through display surface 4 of a battle space with zone spaces not shown but with probable friendly army units 38 and out of sight probable friendly army unit 38A, and probable unfriendly air-force unit 41 being intercepted by probable friendly air-force unit 37.

FIGS. 20, 21, 22, and 23 show weather spaces in ATC, pilot, ground, and marine views for the see-through display surface 4. In FIG. 20, an ATC tower 27 view of the see-through display surface 4 with an out of sight aircraft 17A with probable predicted non-collision course predicted position vector 20 but is occluded by critical weather space 53 (extreme weather zone, such as hurricane, tornado, or typhoon) above probable safe terrain surface 8. Other weather spaces marked as probable safe weather space 51 (calm weather zone), and probable cautious weather space 52 (moderate weather zone) are all shown in FIG. 20. A top-down view of ATC tower 27 is shown on the bottom left of FIG. 20 with multiple users 6 viewing through ATC planar windows 4A, 4B, 4C.

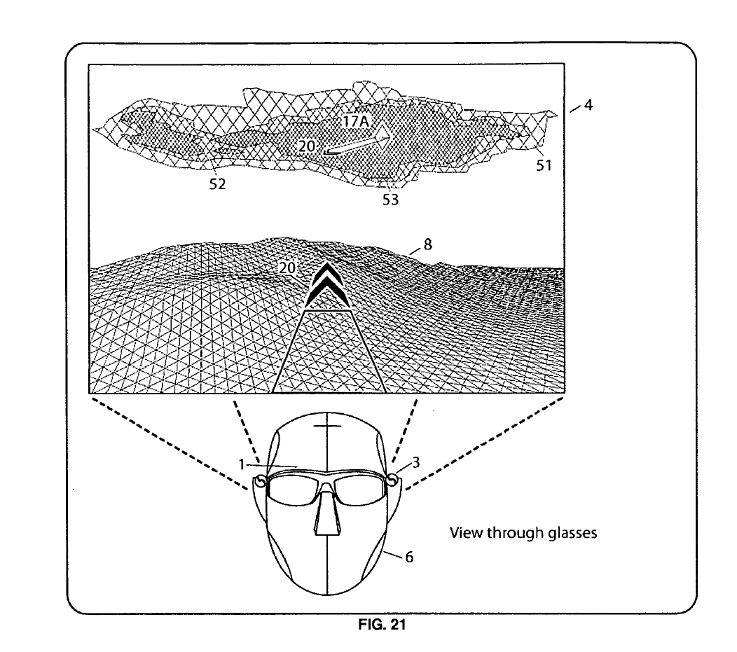

In FIG. 21 is a pilot view of the see-through display surface 4 with an out of sight aircraft 17A not on a predicted collision course, but occluded directly behind critical weather space 53 but near probable safe weather space 51 and probable cautious weather space 52. Also shown are probable safe terrain surface 8 and pilots' probable predicted position vectors 20.

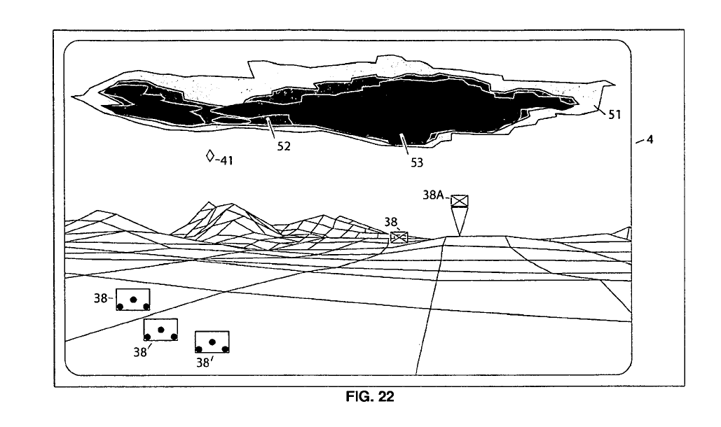

In FIG. 22 is a battle field view for the see-through display surface 4 with weather spaces marked as probable safe weather space 51, probable cautious weather space 52, and probable critical weather space 53 with probable unfriendly air force unit 41 and probable friendly in-sight army units 38. Although not shown, probable friendly and probable unfriendly units can be identified and augmented with highlights such as with different colors or shapes and behavior to clarify what type (probable friendly or probable unfriendly) it is identified as. Many techniques can be used to determine if another unit is probably friendly or probably not friendly, such as time based encoded and encrypted transponders, following of assigned paths, or other means.

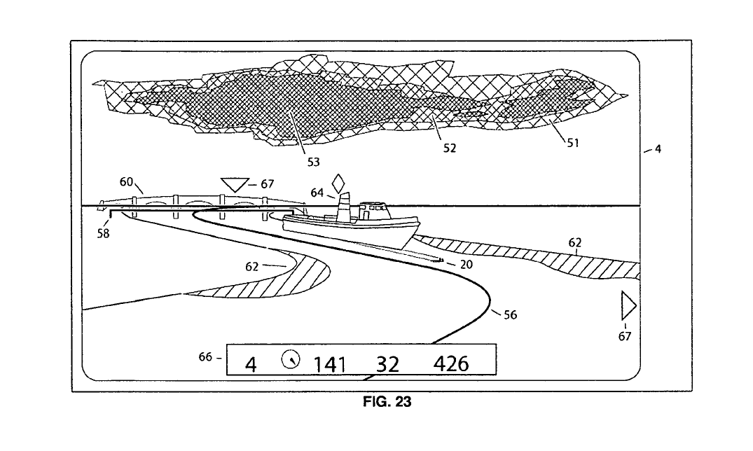

In FIG. 23 a marine application for the HUD system 1 is shown through the see-through display surface 4 having navigation path plan 56 with approaching ship 64 with predicted position vector 20, dangerous shoals 62, essential parameter display 66, bridge 60, unsafe clearance 58, an out-of-sight ship indicator 67 behind bridge 60 and at bottom right of see-through display surface 4. Also shown are critical weather space 53, probable safe weather space 51, and probable cautious weather space 52. Not shown in FIG. 23 but the see-through display surface 4 can be augmented with common National Oceanographic and Atmospheric Administration (NOAA) chart data or Coastal Pilot items such as ship wrecks, rocky shoals, ocean floor types or other chart data. This is also applicable for aviation displays using similar augmentation from aeronautical chart data. Also not shown in FIG. 23, but can be augmented is the surface and depth of the floor of the ocean, river, or channel, or lake, along with tidal, river, or ocean current vectors on the water, known probable fishing net lines, moors, wind direction and magnitude indication, navigation buoy augmentations, as well as minimum and maximum tide levels.

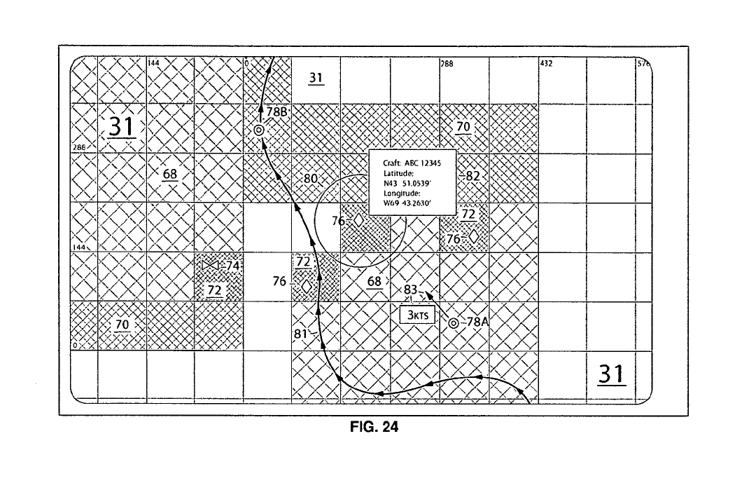

In FIG. 24 the see-through display surface 4 shows a high level view of a coast guard search and rescue operation over water 31 with a search vessel 76 rescue path 81 that found initial reported point of interest 78A identified in an area already searched 68 and projected probable position of point of interest 78B in unsearched area along planned rescue path 81 based on prevailing current vector 83. A prevailing current flow beacon (not shown in FIG. 24) can be immediately dropped into the water 31, to increase the accuracy of prevailing current flows to improve the probability of the accuracy of predicted point of interest 78B. Improvement to the accuracy of the predicted point of interest 78B position can be achieved by having a first on arrival high speed low flying aircraft drop a string of current flow measuring beacon floats (or even an initial search grid of them) with Global Positioning System (GPS) transponder data to measure current flow to contribute to the accuracy of the predicted drift position in the display.

The known search areas on the water are very dynamic because of variance in ocean surface current that generally follows the prevailing wind, but with a series of drift beacons with the approximate dynamics as a floating person dropped along the original point of interest 78A (or as a grid), this drift flow prediction can be made much more accurate and allow the known and planned search areas to automatically adjust with the beacons in real-time. This can reduce the search time and improve the accuracy of predicted point of interest 78B, since unlike the land, the surface on the water moves with time and so would the known and unknown search areas.

An initial high speed rescue aircraft (or high speed jet drones) could automatically drop beacons at the intersections of a square grid (such as 1 mile per side, about a hundred beacons for 10 square miles) on an initial search, like along the grid lines of FIG. 24 where the search area would simply be warped in real-time with the position reports fed back from the beacons to re-shape the search grid in real time. Each flow measuring beacon can have a manual trigger switch and a flashing light so if a swimmer (that does not have a working Emergency Position Indicating Radio Beacon—EPIRB device) capable of swimming towards the beacon sees it and is able to get near it to identify they have been found. People are very hard to spot in the water even by airplane, and especially at night, and what makes it even more challenging is the currents move the people and the previously searched surfaces.

Another way to improve the search surface of FIG. 24 (and can be applied in other applications is use by border agents and by military to spot unfriendly's, friendly's, or intruders) can be by having a linear array of high powered infrared capable telescopic cameras (like an insect eye) mounted on a high speed aircraft zoomed (or telescoped) way-in, much farther than a human eye (like an eagle or birds eye, but having an array of them, such as 10, 20, or more telescopic views) and use high speed image processing for each telescopic camera to detect people. The current flow beacons as well as data automatically processed and collected by the telescopic sensor array can be used to augment the see-through display surface 4.

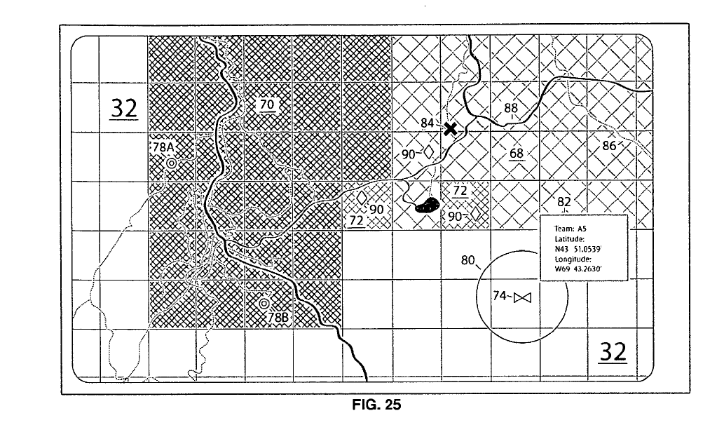

A ground search application for the see-through display surface 4 for the HUD system 1 is shown in FIG. 25 where a last known reported spotting of a hiker 84 was reported near ground search team positions 90 and rivers 88. The hikers reported starting position 78A and destination position 78B reported planned are shown along hiking trails 86. Search and rescue aircraft 74 is shown as selected search unit with selected data 82 shown. Although not shown in FIG. 25 the searched areas and searched hiking trails can be marked with appropriate colors to indicate if they have already searched and have the colors change as the search time progresses to indicate they may need to be searched again if the lost hiker has moved into that area based on how far nearby unsearched areas or trails are and a probable walking speed based on the terrain.

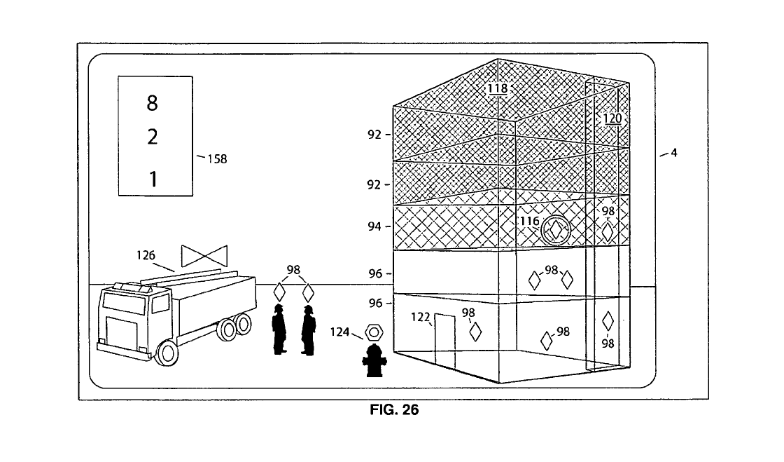

FIG. 26 shows an emergency response in see-through display surface 4 to a building 118 under distress shown with stairwell 120, fire truck 126, fire hydrant 124, and main entrance 122. Inside the building 118 may be floors in unknown state 92, floors actively being searched 94 and floors that are cleared 96. Firefighters 98 are shown outside and on the first three floors, with a distress beacon activated 116 on a firefighter on the third actively searched floor 94. Communications between components of the HUD system 1 can be achieved by using appropriate frequency bands and power levels that allow broadband wireless signals to propagate effectively and reliably through various building 118 structures, and repeaters can be added if necessary or the HUD system 1 itself can be used as a repeater to propagate broadband real-time data throughout the system. Broadcast data can also be sent to all users of the HUD system 1 to order a simultaneous evacuation or retreat if sensors and building engineers indicate increasing probability of a building on the verge of collapsing or if some other urgency is identified, or just to share critical data in real-time.

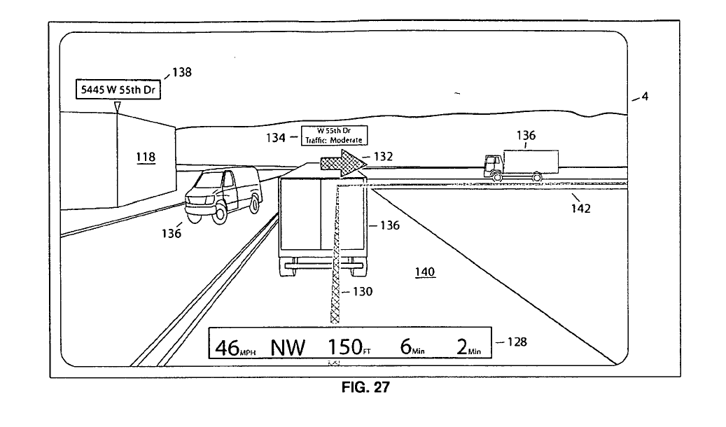

FIG. 27 shows a ground vehicle application view for the see-through display surface 4 where a ground vehicle parameter display 128 is augmented onto the see-through display surface 4 on top of a road 140 and planned route 130. Other vehicles 136 are shown on the road and can be augmented with data, such as speed and distance, as appropriate but not shown in FIG. 27. Upcoming turn indicator 132 is shown just below street and traffic status label 134 for road 142 to be turned on. Address label 138 is shown augmented on the see-through display surface 4 in the upper left of FIG. 27 used to aid the driver in identifying the addresses of buildings. The address label can be augmented to the corner of the building 118 by image processing such as segmentation of edges and known latitude and longitude of the building 118.

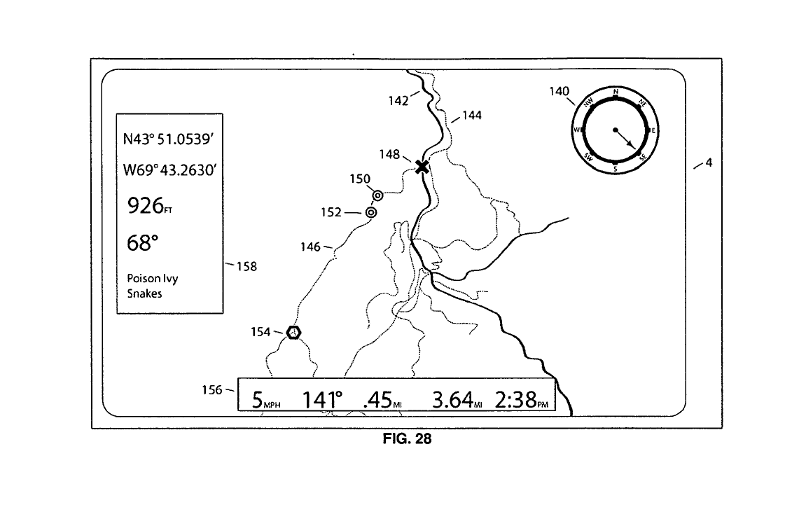

FIG. 28 shows a leisure hiking application view for the see-through display surface 4 of the goggles for the HUD system 1 in opaque mode with a map of the current hiking area with real time compass display 140, bottom parameter display 156 and side display 158 all of which can be augmented onto goggle through the see-through display surface 4 in see-through mode in addition to opaque mode shown in FIG. 28. Also shown in the see-through display surface 4 are rivers 142, inactive hiking trails 144 and active hiking trails 146. A destination cross-hair 148 is shown near the current position 150 with position of others in a group are shown as 152. A point of origin 154 is also shown near bottom left of trails 146 on the see-through display surface 4. Various highlights of color not shown in FIG. 28 can be used to augment different real-time data or different aspects of the see-through display surface 4.

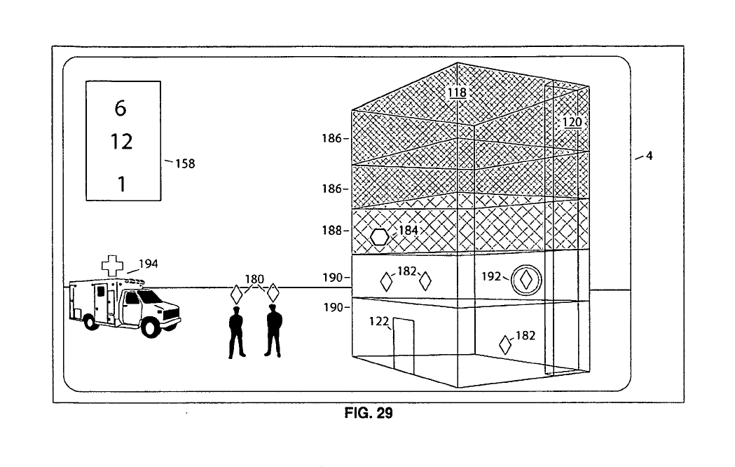

FIG. 29 shows a police or swat team application for the HUD system 1 having the see-through display view 4 with a side display augmentation 158 showing pertinent data relevant to the situation, with an emergency vehicle 194, police units on sight 180 with a building 118 in view. Inside the building police units not visible 182 are augmented on the first two floors marked as safe floors 190, where on the first floor a main entrance 122 is augmented. A second floor is shown augmented with an emergency beacon 192 as activated, and on the third floor is a probable hostage location 184 marked as the possible hostage floor 188. The top two floors (fifth and sixth) are marked as unknown floors 186, where the statuses of those floors are not currently known. Each personnel inside and outside the building or elsewhere can also be utilizing the HUD system 1 to assess the situation and better coordinate a rescue operation.

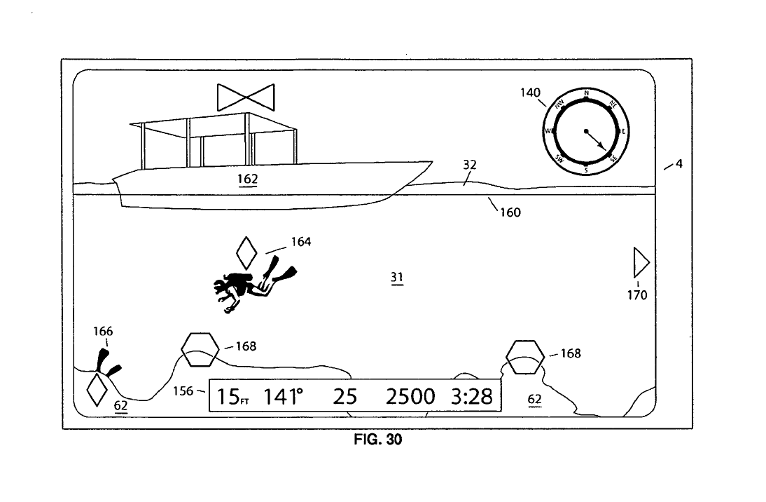

FIG. 30 shows a diver application for an augmented see-through display surface 4 with a dive boat 162 on top of water surface 160, in front of land 32, floating on top of water 31 shown with diver 164 below and diver 166 obstructed by reef 62 with high points 168 augmented. Also shown in FIG. 30 is an indicator of something of interest 170 on the right side of the see-through augmented display surface 4 along with a parameter display 156 at bottom of augmented see-through display surface 4 with critical dive parameters to aid the diver in having a safer diving experience.

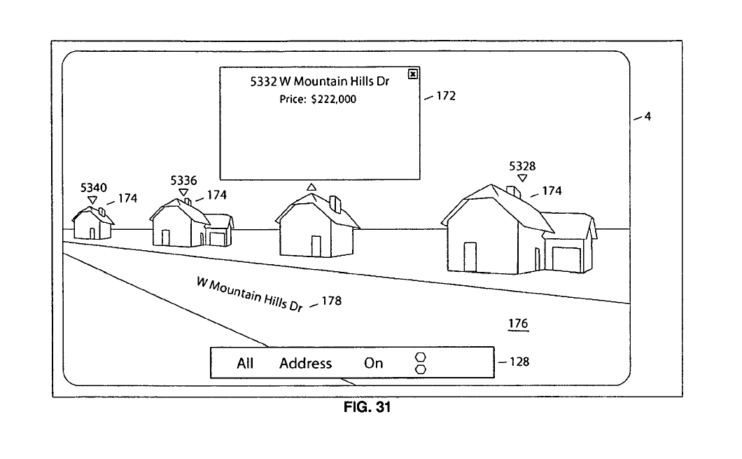

FIG. 31 shows an application for the see-through display surface 4 for a real estate agent providing augmented display data on a selected house 172 showing any details desired, including a virtual tour, among other homes not selected 174 along street 176 with street label 178, and vehicle data display 128 augmented with real estate data on bottom of see-through display surface 4 shown. Address labels are augmented on the see-through display surface 4 above selected homes 174 using latitude and longitude data along with head-orientation data to align the address labels above the homes.

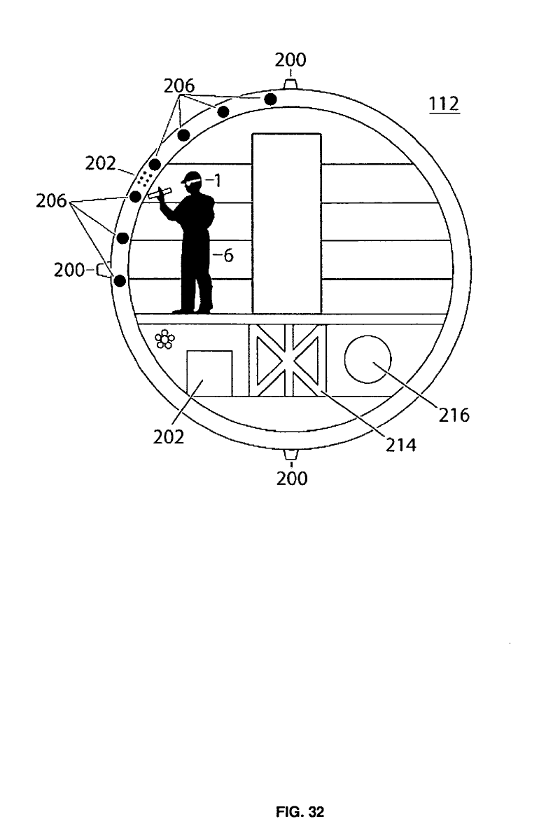

FIG. 32 shows a technician-user 6 installing a part inside an aircraft fuselage with space of interest 112 orientation sensor systems 200 are shown installed for temporary frame of reference during manufacturing where technician-user 6 is shown with a wearable HUD system 1 where electrical lines 202 and hydraulic lines 206 are augmented to be visible to technician-user 6. The position of the space of interest orientation sensor systems 200 can be pre-defined and are such that the frame of reference can be easily calibrated and communicate with the HUD system 1 so that the augmentations are correctly aligned. The orientation sensor systems 200 provide the frame of reference to work with and report their relative position to the HUD system 1. The orientation sensors 200 can use wireless communications such as IEEE 802.11 to report relative distance of the HUD system 1 to the orientation sensors 200. Any type of sensor system 200 (such as wireless ranging, acoustic ranging, optical ranging, etc.) can be used to provide relative distance and orientation to the frame of reference, and the position and number of the points of reference are only significant in that a unique frame of reference is established so that the structure of geometry from the data are aligned with the indication from the orientation sensor systems 200. Other parts of the aircraft such as support beams 214, and ventilation tube 216 are all shown and can be augmented to user 6 even though they are blocked by the floor.

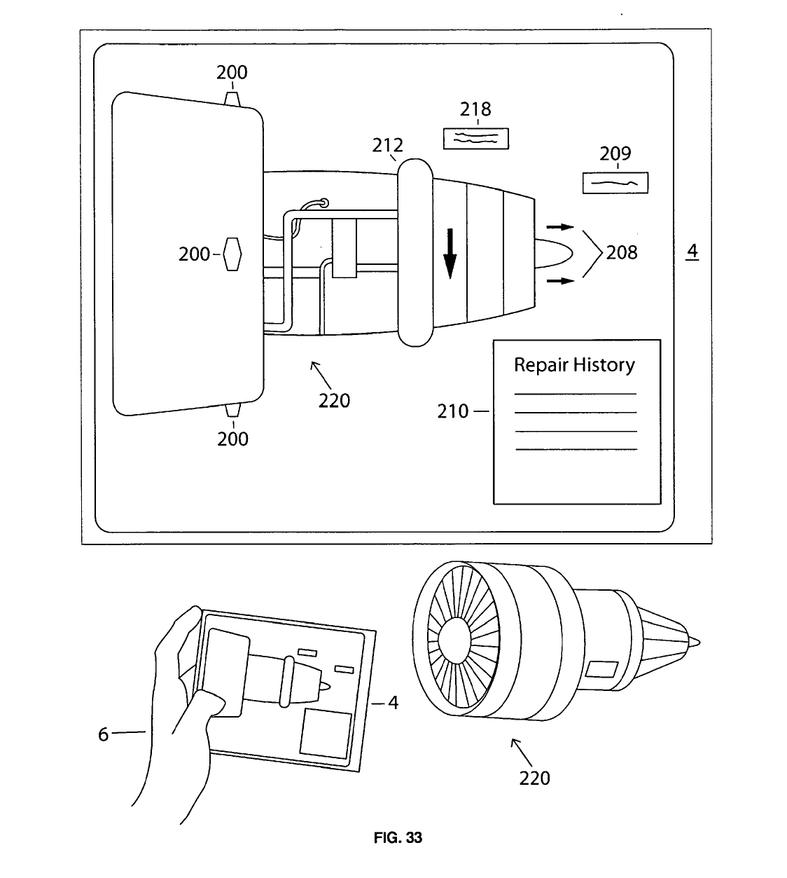

The top part of FIG. 33 shows the see-through display surface 4 of a hand-held application with user 6 holding augmented see-through display surface 4 on the bottom part of FIG. 33 shown in front of a disassembled aircraft engine with temporary orientation sensor systems 200 mounted for a frame of reference. Exhaust tubing 212 is augmented as highlighted with part number 218 augmented near the part. Flow vectors 208 and speed indication 209, along with repair history data 210 are also shown on the right side of the display. The user 6 can move the display to specific areas to identify occluded (invisible) layers underneath and to help identify parts, their history, function, and how they are installed or removed.

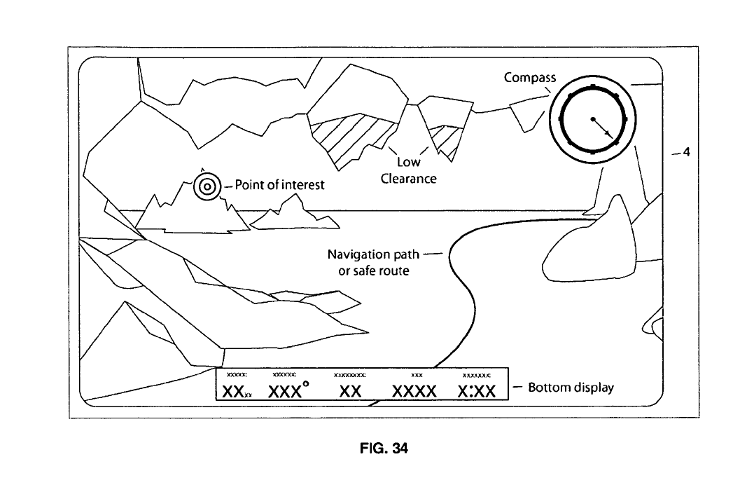

FIG. 34 shows an augmented see-through display surface 4 of a spelunking application using cave data, where augmentation is determined by inertial navigation using accelerometers, magnetic sensors, altimeter, Very Low Frequency (VLF) systems, or other techniques to retrieve position data to establish the alignment of the augmentation in a cave environment.

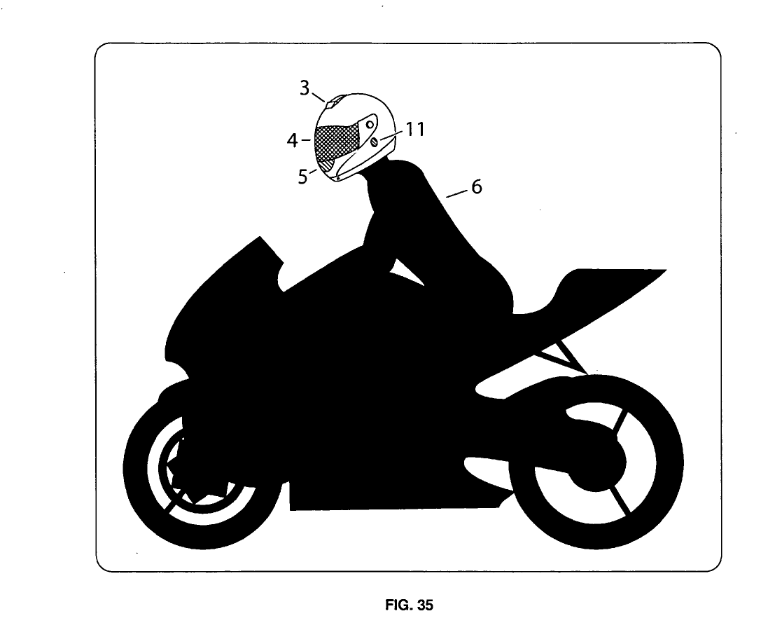

FIG. 35 shows application of HUD system 1 by a motorcyclist-user 6 where the helmet is part of the HUD system 1, or the HUD system 1 is worn inside the helmet by the motorcyclist-user 6 where the display is controlled by voice command, eye tracking, or other input device.

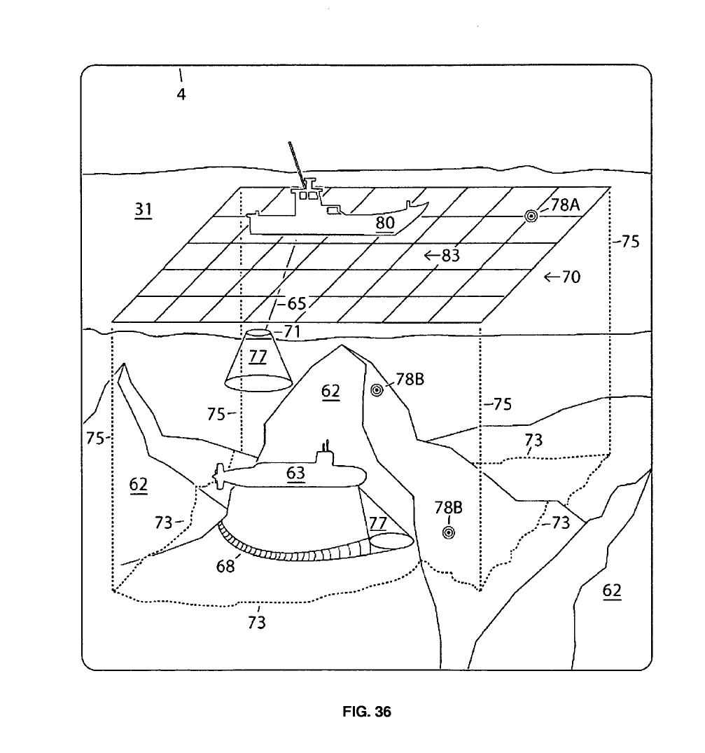

FIG. 36 shows an augmented see-through display surface 4 of an underwater search area as viewed by a search team commander (such as from vantage point of an aircraft) with water 31 surface search grid 70 with surface current 83 and search vessel 80 dragging sensor 71 by drag line 65 with sensor cone 77. Search grid 70 corner debt lines 75 are shown from the corners of search grid 70 going beneath surface of water 31 along with search edge lines 73 projected onto bottom surfaces 62. Search submarine 63 with sensor cone 77 is shown near bottom surface 62 with already searched path 68 shown heading towards predicted probable positing of points of interest 78B based on dead reckoning from previous data or other technique from original point of interest 78A on surface of water 31. Techniques described for FIG. 24 apply for FIG. 36 as well, such as utilizing an initial dropped grid of surface flow beacons at each interval of search grid surface 70 to accurately identify surface drift on water 31 from time and initial spotting of debris as well as from first report of missing location, to pinpoint highest probability of finding objects of interest on bottom surface of water 62. The grid of surface beacons could be extended to measure depth currents as well, by providing a line of multiple spaced flow sensors down to bottom surface 62 providing data for improved three dimensional prediction of probable point of interests 78B on bottom surface 62.

Sonar data or data from other underwater remote sensing technology from surface reflections from sensor cones 70 of surface 62 can be used to compare with prior known data of surface 62 data where the sensor 71 data can be made so it is perfectly aligned with prior known data of surface 62, if available, whereby differences can be used to identify possible objects on top of surface 62 as the actual point of interest 78B.

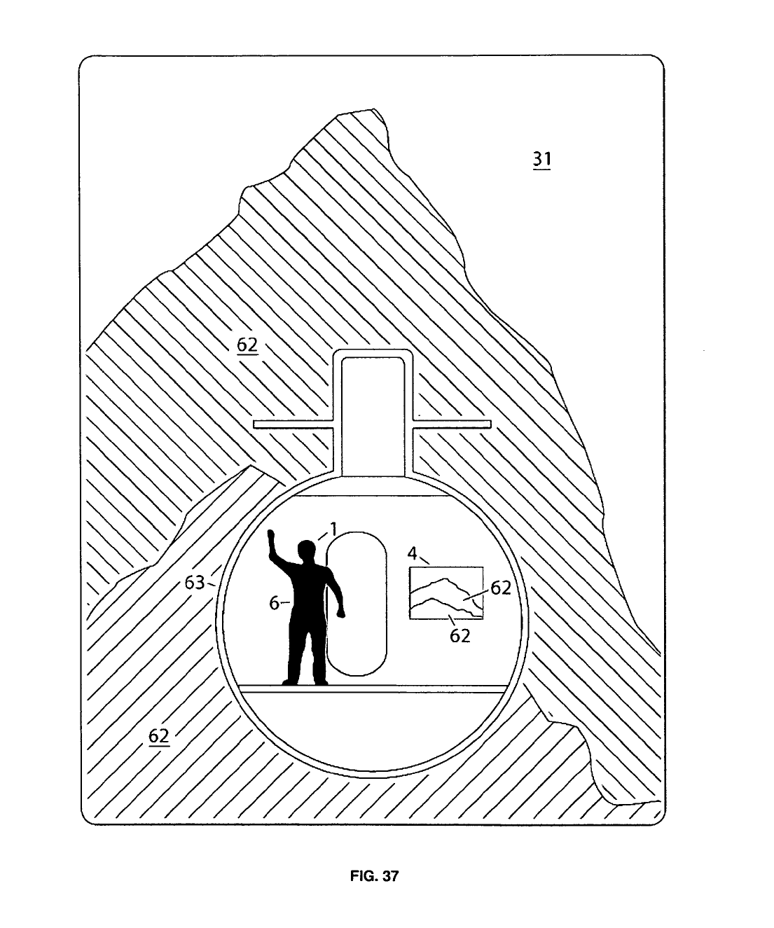

FIG. 37 shows a cross section of a submarine 63 underwater 31 near bottom surfaces 62. The see-through display surface 4 is shown mounted where underwater mountain surfaces 62 are shown inside display surface 4 that correspond to bottom surfaces 62 shown outside submarine 32. Also shown is user 6 wearing HUD system 1 where orientation of augmentation matches the head of the user 6. Here the HUD system 1 and the see-through display surface 4 can serve as an aid to navigation for submarines.

All the figures herein show different display modes that are interchangeable for each application, and is meant to be just a partial example of how augmentation can be displayed. The applications are not limited to one display mode. For instance, FIG. 31 shows a ground view, but can also show a high level opaque mode view of the property a view high above ground looking down.

This invention is not limited to aircraft, but can be just as easily applied to automobiles, ships, aircraft carriers, trains, spacecraft, or other vessels, as well as be applied for use by technicians or mechanics working on systems.

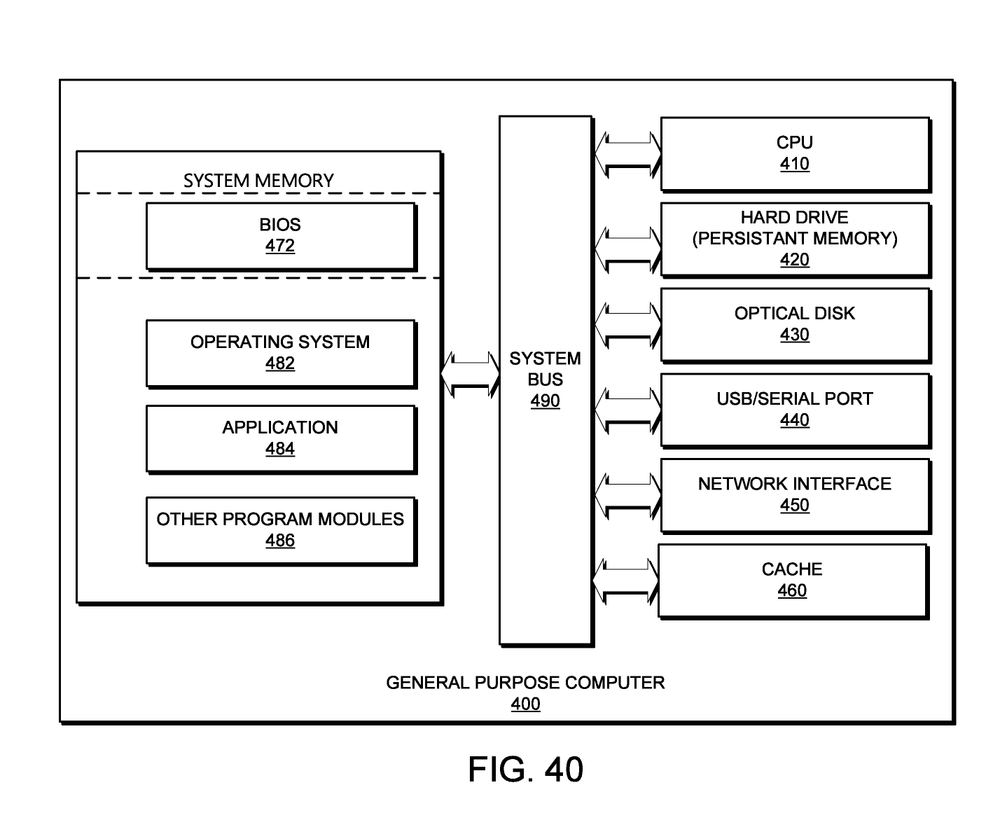

FIG. 40 illustrates an example general purpose computer 400 that may be useful in implementing the described systems (e.g. the HUD system 1). The example hardware and operating environment of FIG. 40 for implementing the described technology includes a computing device, such as general purpose computing device in the form of a personal computer, server, or other type of computing device. In the implementation of FIG. 40, for example, the general purpose computer 400 includes a processor 410, a cache 460, a system memory 420 and a system bus 490 that operatively couples various system components including the cache 460 and the system memory 420 to the processor 410. There may be only one or there may be more than one processor 410, such that the processor of the general purpose computer 300 comprises a single central processing unit (CPU), or a plurality of processing units, commonly referred to as a parallel processing environment. The general purpose computer 400 may be a conventional computer, a distributed computer, or any other type of computer; the disclosure included herein is not so limited.

The system bus 490 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) and random access memory (RAM). A basic input/output system (BIOS), containing the basic routines that help to transfer information between elements within the general purpose computer 400 such as during start-up may be stored in ROM. The general purpose computer 400 further includes a hard disk drive 420 for reading from and writing to a persistent memory such as a hard disk, not shown and an optical disk drive 430 for reading from or writing to a removable optical disk such as a CD ROM, DVD, or other optical medium.

The hard disk drive 420 and optical disk drive 430 are connected to the system bus 490. The drives and their associated computer-readable medium provide nonvolatile storage of computer-readable instructions, data structures, program engines and other data for the general purpose computer 400. It should be appreciated by those skilled in the art that any type of computer-readable medium which can store data that is accessible by a computer, such as magnetic cassettes, flash memory cards, digital video disks, random access memories (RAMs), read only memories (ROMs), and the like, may be used in the example operating environment.

A number of program engines may be stored on the hard disk, optical disk, or elsewhere, including an operating system 482, an application 484, and one or more other application programs 486. A user may enter commands and information into the general purpose computer 400 through input devices such as a keyboard and pointing device connected to the USB or Serial Port 440. These and other input devices are often connected to the processor 410 through the USB or serial port interface 440 that is coupled to the system bus 490, but may be connected by other interfaces, such as a parallel port. A monitor or other type of display device may also be connected to the system bus 490 via an interface (not shown). In addition to the monitor, computers typically include other peripheral output devices (not shown), such as speakers and printers.

The embodiments of the present disclosure described herein are implemented as logical steps in one or more computer systems. The logical operations of the present disclosure are implemented (1) as a sequence of processor-implemented steps executing in one or more computer systems and (2) as interconnected machine or circuit engines within one or more computer systems. The implementation is a matter of choice, dependent on the performance requirements of the computer system implementing aspects of the present disclosure. Accordingly, the logical operations making up the embodiments of the disclosure described herein are referred to variously as operations, steps, objects, or engines. Furthermore, it should be understood that logical operations may be performed in any order, unless explicitly claimed otherwise or a specific order is inherently necessitated by the claim language.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the disclosure and are thus within the spirit and scope of the present disclosure. From the above description and drawings, it will be understood by those of ordinary skill in the art that the particular embodiments shown and described are for purposes of illustrations only and are not intended to limit the scope of the present disclosure. References to details of particular embodiments are not intended to limit the scope of the disclosure.

1. A system for generating a head-up-display comprising:
at least one processor to:
determine an orientation of an interface to display a three-dimensional stereographic space comprising a space of interest, the space of interest defining a point-of-view corresponding to the interface, the three-dimensional stereographic space corresponding to a real-world environment;
generate the three-dimensional stereographic space based on the orientation and geographical information corresponding to the space of interest;
obtain augmentation data corresponding to the space of interest; and
generate for display on the interface, an augmented view of the space of interest based on the augmentation data.

2. The system of claim 1, wherein the interface is a head-mountable device comprising:
a display surface for displaying the space of interest;
at least one sensor positioned to optically track a direction of at least one eye of a user;
at least one head orientation sensor to track a head movement of the user; and
wherein the direction and head movement of the user are processed by the at least one processor to determine the orientation of the user.

3. The system of claim 2, wherein the display surface is communicatively connected to the at least one processor, the at least one sensor is communicatively connected to the at least one processor, and the at least one head orientation sensor is communicatively connected to the at least one processor.

4. The system of claim 2, wherein the at least one processor is further configured to:
update the augmentation data based on movement of the user's head; and
display the updated augmentation data at the display surface.

5. The system of claim 1, wherein geographical information includes at least two digital images of the space of interest and wherein the at least one processor is further configured to generate the three-dimensional stereographic space by stitching the at least two digital images together with overlapping fields of view.

6. The system of claim 1, wherein the geographical information includes radar data identifying at least one object in the space of interest, the radar data received from a space data storage and retrieval center and wherein the at least one processor is further configured to generate the three-dimensional stereographic space by displaying the at least one object in the space of interest.

7. The system of claim 1, wherein the real-world environment is a pilot view, wherein the augmented data comprises safe terrain surfaces, cautionary terrain surfaces, and critical terrain surfaces, and wherein the user is a pilot.

8. The system of claim 1, wherein the augmented data includes at least one of tactical data, three-dimensional environmental data, three-dimensional weather data, three-dimensional obstacle data, or three-dimensional terrain data.

9. The system of claim 2, wherein the head-mountable device comprises goggles.

10. A method for generating a head-up-display comprising:
determining, using at least one processor, an orientation of an interface to display a three-dimensional stereographic space comprising a space of interest, the space of interest defining a point-of-view corresponding to the interface, the three-dimensional stereographic space corresponding to a real-world environment;
generating, using the at least one processor, the three-dimensional stereographic space based on the orientation and geographical information corresponding to the space of interest;
obtaining, using the at least one processor, augmentation data corresponding to the space of interest; and
generating for display on the interface, an augmented view of the space of interest based on the augmentation data.

11. The method of claim 10, wherein the interface is a head-mountable device comprising:
a display surface for displaying the space of interest;
at least one sensor positioned to optically track a direction of at least one eye of a user;
at least one head orientation sensor to track a head movement of the user; and
wherein the direction and head movement of the user are processed by the at least one processor to determine the orientation of the user.

12. The method of claim 11, wherein the display surface is communicatively connected to the at least one processor, the at least one sensor is communicatively connected to the at least one processor, and the at least one head orientation sensor is communicatively connected to the at least one processor.

13. The method of claim 10, further comprising:
updating the augmentation data based on movement of the user's head; and
displaying the updated augmentation data at the display surface.

14. The method of claim 10, wherein geographical information includes at least two digital images of the space of interest and wherein the at least one processor is further configured to generate the three-dimensional stereographic space by stitching the at least two digital images together with overlapping fields of view.

15. The method of claim 10, wherein the geographical information includes radar data identifying a location of the space of interest, the radar data received from a space data storage and retrieval center, and wherein the at least one processor is further configured to generate the three-dimensional stereographic space by displaying the space of interest according to the location.

16. The method of claim 10, wherein the real-world environment is a pilot view, wherein the augmented data comprises safe terrain surfaces, cautionary terrain surfaces, and critical terrain surfaces, and wherein the user is a pilot.

17. The method of claim 10, wherein the augmented data includes at least one of tactical data, three-dimensional environmental data, three-dimensional weather data, three-dimensional obstacle data, or three-dimensional terrain data.

18. The method of claim 11, wherein the head-mountable device comprises goggles.

19. A system for generating a head-up-display comprising:
a head-mountable device comprising a display surface, the head-mountable device in operable communication with at least one processor, the at least one processor to:
determine an orientation of the head-mountable device to display at the displace surface, a three-dimensional stereographic space comprising a space of interest, the space of interest defining a point-of-view corresponding to the head-mountable device, the three-dimensional stereographic space corresponding to a real-world environment;
generate the three-dimensional stereographic space based on the orientation and geographical information corresponding to the space of interest;
obtain augmentation data corresponding to the space of interest;
generate for display on the display surface, an augmented view of the space of interest based on the augmentation data;
update the augmentation data based on movement of the user's head; and
display the updated augmentation data at the display surface.

20. The system of claim 19, wherein geographical information includes at least two digital images of the space of interest and wherein the at least one processor is further configured to generate the three-dimensional stereographic space by stitching the at least two digital images together with overlapping fields of view.

21. A system for generating a head-up-display comprising:
at least one processor to:
determine an orientation of an interface to display a three-dimensional stereographic space comprising a space of interest defining a point-of-view of the interface, the three-dimensional stereographic space corresponding to a real-world environment; and
generate the three-dimensional stereographic space by:
based on the orientation, receiving at least two digital images of the space of interest, a first digital image corresponding to a first eye of the user and a second digital image corresponding to a second eye of the user, the first digital image of a seven degree difference in relation to the second digital image.

22. The system of claim 21, wherein the at least one processor is further configured to:
obtain augmentation data corresponding to the space of interest; and
generate for display on the interface, an augmented view of the space of interest based on the augmentation data.

23. The system of claim 22, wherein the augmented data includes at least one of tactical data, three-dimensional environmental data, three-dimensional weather data, three-dimensional obstacle data, or three-dimensional terrain data.

24. The system of claim 21, wherein the interface is a head-mountable device comprising:
a display surface for displaying the space of interest;
at least one sensor positioned to optically track a direction of at least one eye of the user;
at least one head orientation sensor to track a head movement of the user; and
wherein the direction and head movement of the user are processed by the at least one processor to determine the orientation of the user.

25. A system for generating a head-up-display comprising:
at least one processor to:
determine an orientation of an interface to display a three-dimensional stereographic space comprising a space of interest defining a point-of-view corresponding to the interface, the three-dimensional stereographic space corresponding to a real-world environment; and
generate the three-dimensional stereographic space based on the orientation and geographical information including at least one of radar data, sensor data, or global positioning data corresponding to the space of interest;
obtain augmentation data corresponding to the space of interest; and
generate for display on the interface, an augmented view of the space of interest based on the augmentation data.

26. The system of claim 25, wherein the radar data, sensor data, or global positioning data corresponding to the space of interest is received from at least one space data storage and retrieval center.

27. The system of claim 25, wherein the interface is a head-mountable device comprising:
a display surface for displaying the space of interest;
at least one sensor positioned to optically track a direction of at least one eye of a user;
at least one head orientation sensor to track a head movement of the user; and
wherein the direction and head movement of the user are processed by the at least one processor to determine the orientation of the user.

28. The system of claim 27, wherein the at least one processor is further configured to:
update the augmentation data based on movement of the user's head; and
display the updated augmentation data at the display surface.

29. The system of claim 25, wherein the radar data identifies at least one object in the space of interest, the radar data received from a space data storage and retrieval center and wherein the at least one processor is further configured to generate the three-dimensional stereographic space by displaying the at least one object in the space of interest.

30. The system of claim 25, wherein the augmented data includes at least one of tactical data, three-dimensional environmental data, three-dimensional weather data, three-dimensional obstacle data, or three-dimensional terrain data.
